(19) United States
(12) Patent Application Publication
(10) Pub. No.: US 2017/0102766 A1
(43) Pub. Date: Apr. 13, 2017

(54) REACTION OUTPUT APPARATUS, REACTION OUTPUT SYSTEM, AND NON-TRANSITORY COMPUTER-READABLE STORAGE MEDIUM

(71) Applicant: FUJITSU LIMITED, Kawasaki-shi (JP)

(72) Inventor: Naoko Hayashida, Yokohama (JP)

(73) Assignee: FUJITSU LIMITED, Kawasaki-shi (JP)

(21) Appl. No.: 15/287,234

(22) Filed: Oct. 6, 2016

(30) Foreign Application Priority Data
Oct. 13, 2015 (JP) 2015-202382

(51) Int. Cl. G06F 3/01; G09G 5/00; G06T 13/40; G06T 7/20

(52) U.S. Cl. CPC G06F 3/011; G06T 7/20; G09G 5/006; G06T 13/40; G09G 2370/16; G06T 13/80

(57) ABSTRACT

A reaction output apparatus including a memory storing image group information including a virtual space and a plurality of avatars, each avatar within the virtual space represents a person in a real space, and a processor configured to obtain sensor information that indicates movement of a first person and a second person, generate an image group based on the virtual space including a first avatar indicating movement of the first person and a second avatar to indicate movement of a second person, determine an action event based on the movement of the first person, wait a period of time to determine if the second person reacts to the movement of the first person, create group representation including the first avatar and the second avatar and the action event, output the group representation to a device associated with the first person and a device associated with the second person.

### CROSS-REFERENCE TO RELATED APPLICATION

This application is based upon and claims the benefit of priority of the prior Japanese Patent Application No. 2015-202382, filed on Oct. 13, 2015, the entire contents of which are incorporated herein by reference.

### FIELD

The embodiments discussed herein are related to a reaction output apparatus, a reaction output system, and non-transitory computer-readable storage medium.

### BACKGROUND

In a scene in which a plurality of people communicate with each other, analyzing what reaction other people have and speculating whether the intimacy is well-balanced with respect to each person's behavior has become important information for building mutual human relationships.

For example, when a person tries to make eye contact with another person, it is possible to speculate that the intimacy between these two people is well-balanced in a case where these two people make eye contact with each other. Meanwhile, in a case where another person has moved his or her body without making eye contact, it is possible to speculate that the balance of intimacy is broken.

In the related art, a technique of supporting communication by sharing information related to these behaviors important for constructing human relationships even in video conferences from remote locations has been known.

As examples of the relate art, Japanese Laid-open Patent Publication No. 2014-110558, Japanese Laid-open Patent Publication No. 2009-77380, Japanese Laid-open Patent Publication No. 2015-75906, and Japanese Laid-open Patent Publication No. 2015-64827 are known.

### SUMMARY

According to an aspect of the invention, a reaction output apparatus including a memory storing image group information including a virtual space and a plurality of avatars, each avatar within the virtual space represents a person in a real space, and a processor configured to obtain sensor information that indicates movement of a first person and a second person, generate an image group based on the virtual space including a first avatar indicating movement of the first person and a second avatar to indicate movement of a second person, determine an action event based on the movement of the first person, wait a period of time to determine if the second person reacts to the movement of the first person, create group representation including the first avatar and the second avatar and the action event, output the group representation to a device associated with the first person and a device associated with the second person.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the entire configuration of a reaction output system;

FIG. 2 is a view illustrating an example of visual field images respectively displayed on HMDs of each user;

FIG. 3 is a first view for describing a relationship between a visual field image and each user's behavior;

FIG. 4 is a second view for describing a relationship between a visual field image and each user's behavior;

FIG. 5 is a view illustrating an example of a display of time series composed image data;

FIG. 6 is a diagram illustrating an example of a hardware configuration of a server device;

FIG. 7 is a diagram illustrating an example of a hardware configuration of a client device;

FIG. 8 is a diagram illustrating an example of a functional configuration of the client device;

FIG. 9 is a flowchart describing sensor data transmission processing executed by the client device;

FIG. 10 is a flowchart describing virtual space displaying processing executed by the client device;

FIG. 11 is a flowchart describing time series composed image data displaying processing executed by the client device;

FIG. 12 is a first view illustrating an example of a functional configuration of the server device;

FIG. 13 is a diagram illustrating an example of a head posture data table;

FIG. 14 is a diagram illustrating an example of a depth data file table;

FIG. 15 is a diagram illustrating an example of a electromyography data table;

FIG. 16 is a flowchart of information providing processing for a virtual space executed by the server device;

FIG. 17 is a second diagram illustrating an example of the functional configuration of the server device;

FIG. 18 illustrates an example of movements of an avatar;

FIGS. 19A and 19B are diagrams illustrating definition information for determining the type of movement of the avatar;

FIGS. 20A and 20B are diagrams illustrating definition information for determining the type of movement of another avatar;

FIG. 21 is a diagram for describing a flow from when a behavior is carried out by a user to when an action event occurs;

FIG. 22 is a flowchart of log recording processing executed by the server device;

FIG. 23 is a diagram illustrating an example of a movement type determination log table of the avatar;

FIG. 24 is a diagram illustrating an example of a movement type determination log table of another avatar;

FIG. 25 is a first diagram for describing a flow from when a behavior is carried out by a user to when time series composed image data is displayed;

FIGS. 26A and 26B are diagrams illustrating an example of a buffer table and an event log table;

FIG. 27 is a diagram illustrating an example of an action event and reaction event log reference table;

FIG. 28 is a diagram illustrating an example of a displaying and reaction log table;

FIGS. 29A and 29B are diagrams illustrating an example of an information reference table for generating time series composed image data and an instruction information reference table for reproducing time series composed image data;

FIG. 30 is a flowchart illustrating information providing processing for time series composed image data executed by the server device;

FIG. 31 is a diagram illustrating an example of time series composed image data displaying log table;

FIG. 32 is a third diagram illustrating an example of the functional configuration of the server device;

FIG. 33 is a diagram illustrating an example of definition information of defining a relationship among the type, tendency, and priority of movement of another avatar; and

FIG. 34 is a second diagram for describing a flow from when a behavior is carried out by a user to when time series composed image data is displayed.

### DESCRIPTION OF EMBODIMENTS

Hereinafter, a case where information related to these behaviors important for construction of human relationships is shared during communication in a virtual reality (VR) space will be examined. In a case of a VR space, a plurality of people who are communicating are present at locations separated from each other and communicate with each other through avatars (images associated with users). Accordingly, the following problems may occur.

For example, it is assumed that movement of an avatar which reflects a user A's behavior is visually recognized by a user B in a remote location and movement of an avatar which reflects the reaction of the user B is visually recognized by the user A. In this case, it takes time for the user A to visually realize the reaction of the user B with respect to the user A's behavior as the movement of the avatar of the user B. Therefore, the user A may not grasp whether his or her own behavior is appropriate or not until the avatar reflecting the reaction of the user B responses by its movement. Further, even when the behavior is inappropriate, the user A may not grasp when the user B determines a series of behaviors of the user A as inappropriate.

That is, in a VR space, it is not easy to grasp the relationship between behaviors of each user and reactions of other users with respect to each of the behaviors and difficult to speculate whether the intimacy is well-balanced.

According to one aspect, an object is to synthetize individual reactions of other people with respect to a person's behavior in a VR space used by a plurality of people and to output the reactions without changing the timing at which each of the reactions with respect to the behavior occurs.

First, the definitions of terms used in the description of a reaction output system of each embodiment described below (first to fourth embodiment) will be simply described. The reaction output system described in each embodiment below provides a VR space used when a plurality of people in locations separated from each other communicate and provides time series composed image data for speculating whether the intimacy is well-balanced.

At the time of providing a VR space, the reaction output system performs a process of converting “a person's behavior” in a real space into “movement of an avatar” in a VR space. The “movement of an avatar” is represented by continuously displaying an “avatar” which is an image of each time frame (time) generated at each time frame (time). A “person's behavior” here may indicate a stylized behavior such as raising a hand or tilting a head which is known as a gesture, but may not be necessarily recognized as a gesture by other people.

An “avatar” of each frame is generated based on “portion information” of each portion of the avatar. The “portion information” of each portion of the avatar is obtained by converting sensor data obtained by sensing a person's behavior in a real space into information related to the state (the position, the rotation angle, and the like) of each portion of the avatar in a VR space. In addition, the “portion information” includes “information related to the type of portion” and “values representing the states of portions (portion values)”.

In other words, the “movement of an avatar” in a VR space is represented as a change (change in portion values of each portion of an avatar) of the “avatar” between each time frame with the lapse of time. Moreover, in each embodiment described below, information in which the movement of an avatar is labeled based on how each portion of the avatar has moved (labeled information related to how a person has behaved in a real space) is referred to as the “type of movement of an avatar”.

In a real space, the same behavior in a real space occasionally has an opposite meaning (determined as a different social behavior) depending on the relationship with other people. Among behaviors, the social behavior indicates a behavior performed with respect to social presence of other people.

For example, when a person's behavior is a behavior of moving forward and there is another person at a place where the person has moved forward, the behavior of the person may be a social behavior of approaching another person (social behavior having a tendency of approaching (reciprocity)). On the contrary, in a case where a person has moved away from another person as a result of a behavior of moving forward in a state in which another person has been at a place close to the person, the person's behavior may be a social behavior of moving away from another person (social behavior having a tendency of avoiding (compensatory)). Similarly, when a person's behavior is a behavior of changing the orientation of his or her face to the right direction and there is another person on the right side, the behavior of the person may be a social behavior of changing the orientation of the face to another person (social behavior having a tendency of approaching). On the contrary, in a case where a person changes the orientation of the face to the right direction in a state in which another person is on the left side, the person's behavior may be a social behavior of turning from another person (social behavior having a tendency of avoiding).

Accordingly, the “movement of an avatar” in a VR space may have an opposite meaning depending on the relationship with other avatars. In the each embodiment described below, determination that which social behavior of a person in a real space the “movement with respect to another avatar” corresponds to is referred to as determination of the “type of movement with respect to another avatar”.

Next, the outline of the reaction output system of each embodiment below will be described. The reaction output system of each embodiment calculates the movement of each avatar based on sensor data obtained by sensing a behavior of a person in a real space. In addition, in a case where a predetermined avatar has moved more than a predetermined amount and this leads to movement of another avatar more than a predetermined amount, the type of movement is determined, time series image data reflecting each movement is generated, and the time series image data is synthesized (composed), thereby generating time series composed image data.

At this time, in the reaction output system of each embodiment, time series image data is synthesized using a time difference according to a deviation between the display timing when movement of a predetermined avatar is displayed such that other avatars may visually recognize the movement and the sensing timing when the behaviors (reactions) of other users are sensed. In this manner, individual reaction of other people with respect to the behavior of the predetermined user can be output as time series composed image data without changing the timing at which each of the reactions with respect to the behavior occurs. As a result, even in a VR space, the relationship between individual behavior of a user and reactions of other users with respect to each of the behaviors may be easily grasped.

Moreover, the reaction output system of each embodiment described below determines the “type of movement with respect to another avatar” corresponding to the determined “type of movement of an avatar” at the time of generating time series image data. Further, the reaction output system of each embodiment generates time series image data based on sensor data used for determining the “type of movement with respect to another avatar”. In this manner, it is possible to generate time series composed image data having image groups reflecting movements of avatars in a VR space, which correspond to social behaviors of people in a real space.

Hereinafter, each embodiment will be described in detail with reference to accompanying drawings. Further, in the present specification and drawings, constituent elements practically having the same functional configuration are denoted by the same reference numeral and the description thereof will not be repeated.

### First Embodiment

Entire Cnfiguration of Raction Output Sstem

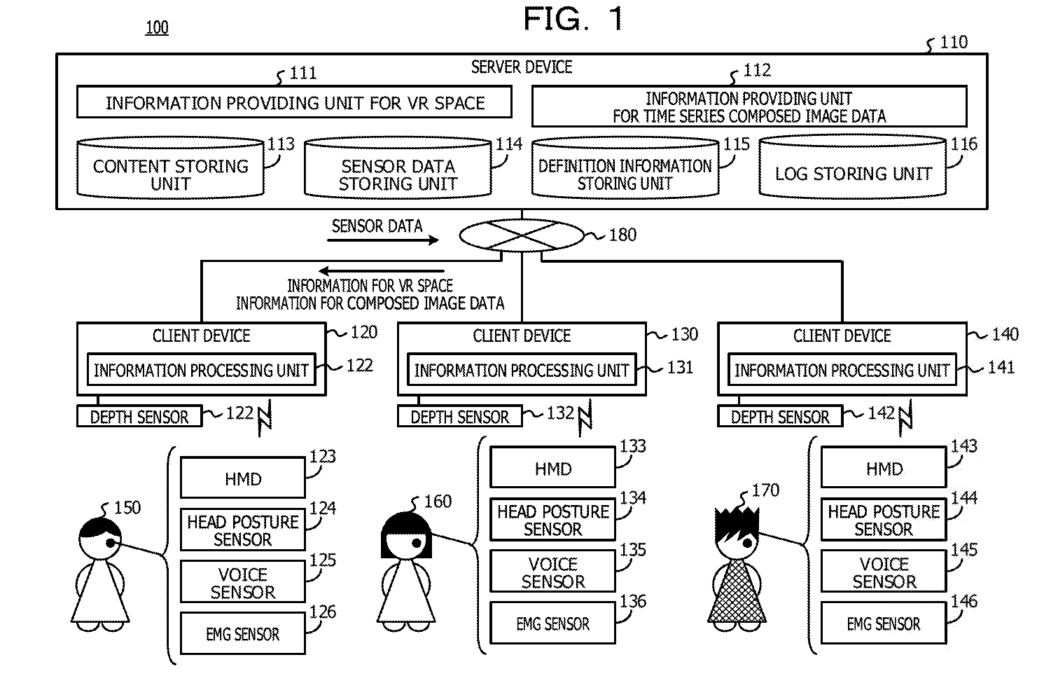

First, the entire configuration of a reaction output system will be described. FIG. 1 is a diagram illustrating an example of the entire configuration of the reaction output system. As illustrated in FIG. 1, a reaction output system 100 includes a server device 110 and client devices 120 to 140 as examples of first to third terminals. The server device 110 is connected to each of the client devices 120 to 140 through a network 180 represented by the Internet or a local area network (LAN).

A user 150 (user name: “user A”, first person), a user 160 (user name: “user B”, second person), and a user 170 (user name: “user C”, third person) use the reaction output system 100 at locations separated from each other. In this manner, the users 150 to 170 are capable of communicating with each other in the same VR space provided by the server device 110. Further, the users 150 to 170 are capable of visually recognizing time series composed image data (the details will be described later) provided by the reaction output system 100. Accordingly, the users 150 to 170 are capable of easily grasping the relationship between the behaviors of each user and the reactions of other users and speculating whether the intimacy is well-balanced.

An information providing program for a VR space and an information providing program for time series composed image data are installed in the server device 110. The server device 110 functions as an information providing unit 111 for a VR space and an information providing unit 112 for time series composed image data by executing these programs.

The information providing unit 111 for a VR space provides a VR space in which the users 150 to 170 communicate with each other. Specifically, the information providing unit 111 for a VR space receives sensor data acquired by sensing behaviors (movement of changing the posture of the body, movement of changing the orientation of the face or facial expressions, speech, and the like) of the users 150 to 170 in a real space from the client device.

Moreover, the sensor data includes data acquired by sensing behaviors other than the above-described behaviors (including movement of the eyegaze of a user) of a user.

The information providing unit 111 for a VR space stores received sensor data in a sensor data storing unit 114. Further, the information providing unit 111 for a VR space calculates portion information of each portion of an avatar at each time in order to express the movement of an avatar in a VR space based on the received sensor data. Moreover, the information providing unit 111 for a VR space generates an avatar at each timer based on the calculated portion information and provides VR space images including generated avatars as information for a VR space together with voice data included in the received sensor data.

At this time, the information providing unit 111 for a VR space generates VR space images (background portion) using background images selected from the background images stored in a content storing unit 113. Further, the information providing unit 111 for a VR space generates avatars using avatar images corresponding to each of the users 150 to 170, selected from the avatar images stored in the content storing unit 113.

The information providing unit 112 for time series composed image data determines whether each portion of avatars of the users 150 to 170 has moved more than a predetermined amount (whether portion information of each portion of avatars is changed more than a predetermined amount) in the VR space provided by the information providing unit 111 for a VR space. In addition, in a case where the information providing unit 112 for time series composed image data determines that each portion of avatars has moved more than a predetermined amount, the information providing unit 112 for time series composed image data generates time series composed image data including the movements and provides the generated time series composed image data so as to be visually recognized by the users 150 to 170. In this manner, the users 150 to 170 are capable of speculating whether the intimacy among the users 150 to 170 is well-balanced.

In addition, the information providing unit 112 for time series composed image data stores various logs, acquired when each processing for providing time series composed image data is executed, in a log table of a log storing unit 116. In this manner (in a manner of analyzing various logs), the administrator of the server device 110 is capable of speculating whether the intimacy among the users 150 to 170 is well-balanced.

An information processing program is installed in the client device 120. The client device 120 functions as an information processing unit 121 by executing the program.

Moreover, a depth sensor 122 is connected to the client device 120. Depth data which is data changing according to the behavior of the user 150 (for example, a behavior of changing the posture of the body) in the real space is output by disposing the depth sensor 122 in the front of the user 150 and measuring the three-dimensional position of the user 150.

In addition, the client device 120 performs wireless communication with a wearable display device or sensor used by the user 150. As a wearable display device in the first embodiment, a head-mounted display (HMD) 123 may be exemplified. The HMD 123 displays VR space images at each time frame with respect to the user 150. In addition, as a wearable sensor in the first embodiment, a head posture sensor 124, a voice sensor 125, and an electromyography (EMG) sensor 126 may be exemplified.

The head posture sensor 124 outputs head posture data which is data related to the “orientation of the head” among behaviors of the user 150 in the real space. The voice sensor 125 outputs voice data which is data related to the “speech” among behaviors of the user 150 in the real space. The EMG sensor 126 outputs EMG data which is data related to the “facial expressions” among the behaviors of the user 150 in the real space.

The HMD 123, the head posture sensor 124, the voice sensor 125, and the EMG sensor 126 are mounted on the head of the user 150. Further, the head posture sensor 124, the voice sensor 125, and the EMG sensor 126 may be built in the HMD 123. Further, wearable sensors may include a sensor that outputs data related to behaviors of the user 150 other than the above-described behaviors. For example, wearable sensors may include a sensor that outputs data in accordance with the direction of the eyegaze among behaviors of the user 150 in the real space.

The client device 120 acquires depth data, head posture data, voice data, and EMG data as sensor data and transmits the sensor data to the server device 110. Further, the client device 120 receives information for a VR space transmitted from the server device 110. In addition, the client device 120 generates VR space images (hereinafter, referred to as “visual field images”) at each time frame (time) when seen from the user 150 based on the received information for a VR space and the acquired sensor data. Moreover, the client device 120 transmits the generated visual field images and the voice data included in the information for a VR space to the HMD 123. In this manner, the user 150 is capable of visually recognizing the VR space and viewing the voice, in the VR space, which is emitted in the real space.

Moreover, the client device 120 receives the information for time series composed image data transmitted from the server device 110 in response to the transmission of the sensor data to the server device 110. The information for time series composed image data is information including time series composed image data suitable for speculating whether the intimacy among the users 150 to 170 is well-balanced. The client device 120 controls the time series composed image data included in the information for time series composed image data to be displayed in the HMD 123 at a predetermined displaying start timing. The predetermined displaying start timing is a timing synchronized with the displaying start timing at which the time series composed image data is displayed in HMD 133 and 143 mounted on the users 160 and 170.

Further, since the functions of the client devices 130 and 140, and display devices, sensors, and the like connected to the client devices 130 and 140 are the same as those of the client device 120, the description thereof will not be repeated.

Description of Visual Field Image in Reaction Output System

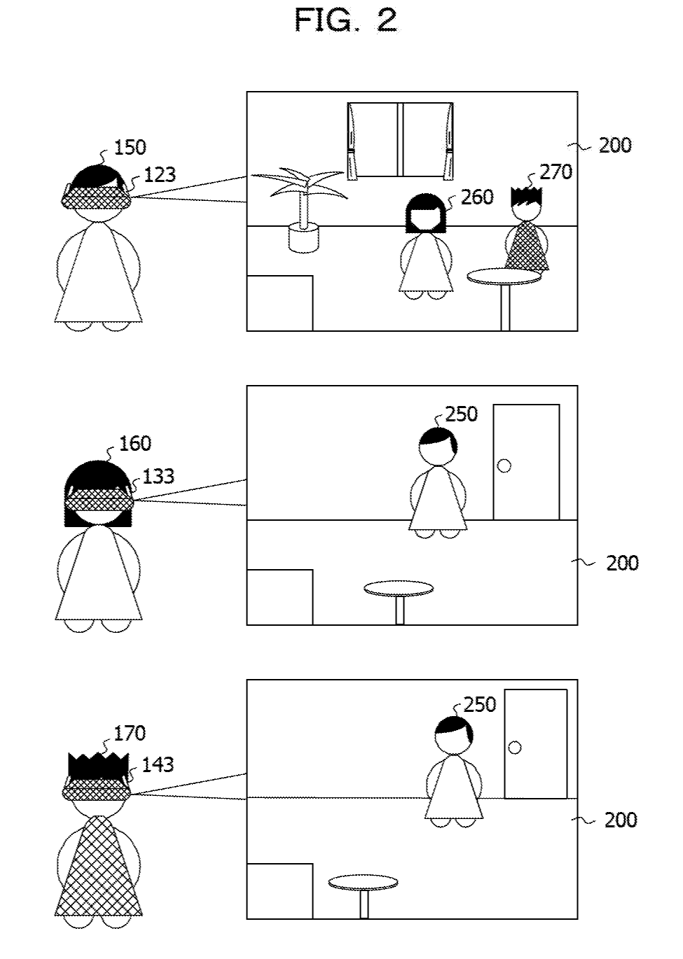

Next, visual field images respectively displayed on the HMD 123, 133, and 143 of the users 150 to 170 will be described. FIG. 2 is a view illustrating an example of visual field images respectively displayed on HMDs of each user.

As illustrated in FIG. 2, an image 200 of the VR space including an avatar 260 (second image) of the user 160 and an avatar 270 (third image) of the user 170 is displayed on the HMD 123 of the user 150 as a visual field image at each time frame (time). In addition, parts (hands and the like) of the avatar of the user 150 are not displayed in the visual field image displayed on the HMD 123 of the user 150, but parts (hands and the like) or the whole avatar of the user 150 may be displayed.

The image 200 of the VR space including an avatar 250 (first image) of the user 150 is displayed on the HMD 133 of the user 160 as a visual field image at each time frame (time). Since the orientation of the user 160 is different from the orientation of the user 150, a visual field image different from the visual field image displayed on the HMD 123 of the user 150 is displayed on the HMD 133 of the user 160 even in a case of the image 200 of the same VR space. In addition, since the user 170 is present on the left side of the user 160 in the image 200 of the VR space, the avatar 270 of the user 170 is not displayed in the visual field image displayed on the HMD 123 of the user 160 in the example of FIG. 2. In addition, parts (hands and the like) of the avatar of the user 160 are not displayed in the visual field image displayed on the HMD 123 of the user 160, but parts (hands and the like) or the whole avatar of the user 160 may be displayed.

The image 200 of the VR space including the avatar 250 of the user 150 is displayed on the HMD 143 of the user 170. Since the orientation of the user 170 is approximately the same as the orientation of the user 160, the same visual field image as that of the HMD 133 of the user 160 is displayed on the HMD 143 of the user 170. In addition, since the user 160 is present on the right side of the user 170 in the image 200 of the VR space, the avatar 260 of the user 160 is not displayed in the image 200 of the VR space displayed on the HMD 123 of the user 170 in the example of FIG. 2. In addition, parts (hands and the like) of the avatar of the user 170 are not displayed in the visual field image displayed on the HMD 123 of the user 170, but parts (hands and the like) or the whole avatar of the user 170 may be displayed.

Description of Relationship Between Behaviors of User and Visual Field Images in Reaction Output System and Time Series Composed Image Data

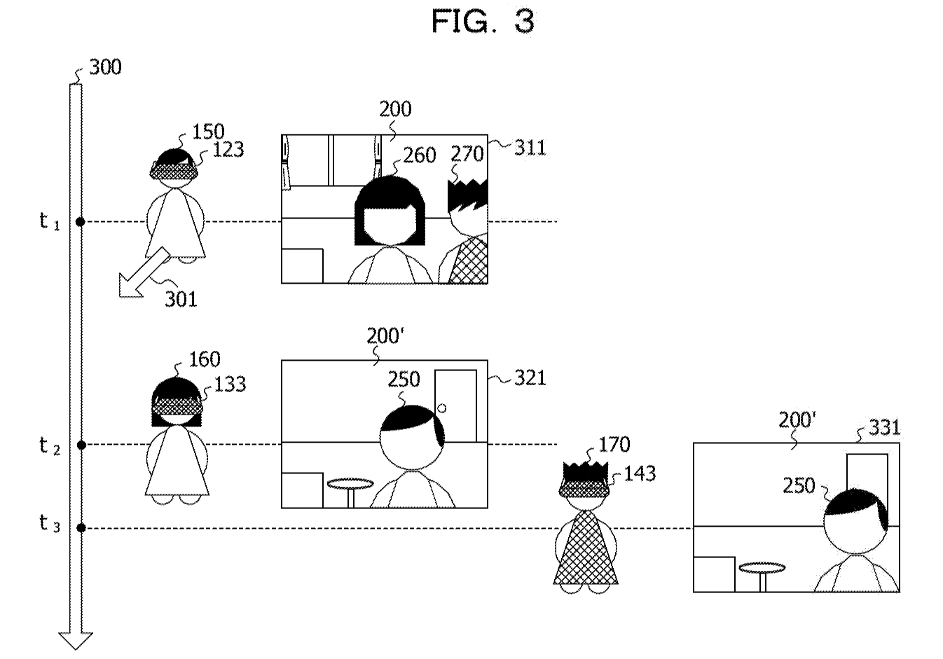

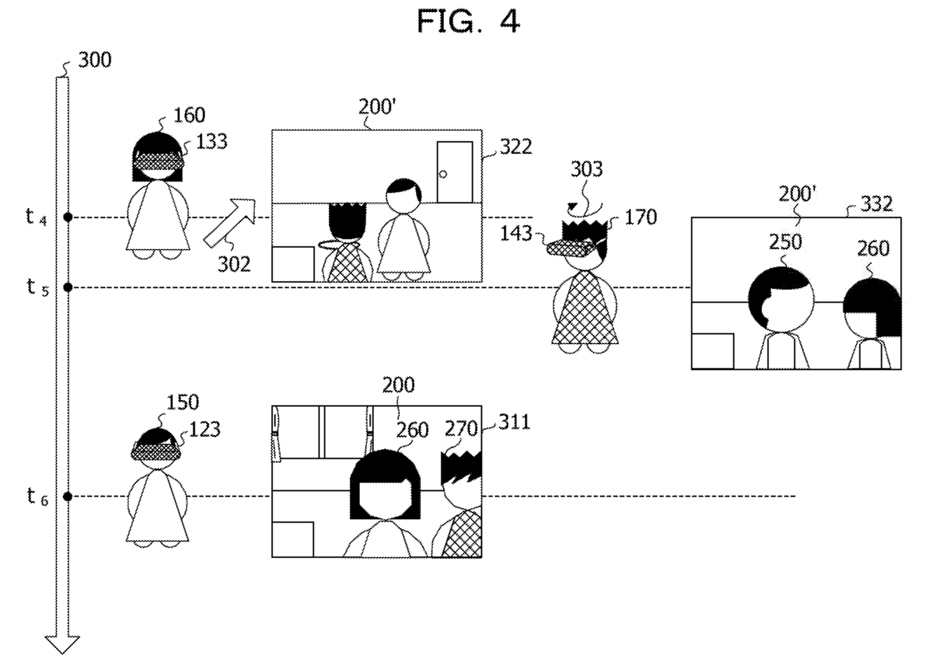

Next, the relationship between the behaviors of the users 150 to 170 and the visual field images in the reaction output system 100 and time series composed image data will be described. FIGS. 3 and 4 are views for describing a relationship between the behaviors of each user and visual field images. An arrow 300 in FIGS. 3 and 4 indicates a time axis.

It is assumed that the user 150 performs a behavior of moving forward (direction of an arrow 301) while maintaining the orientation of the body in the real space at a time t1. When the client device 120 acquires sensor data obtained by sensing the behaviors of the user 150, the client device 120 updates visual field images of the user 150 in the image 200 of the VR space. A visual field image 311 represents a visual field image after the updating. When the user 150 performs a behavior of moving forward in the real space, the avatar 250 of the user 150 approaches the avatar 260 of the user 160 and the avatar 270 of the user 170 in the image 200 of the VR space. In this manner, the visual field image 311 becomes an image representing a state in which the avatar 250 of the user 150 approaches the avatar 260 and the avatar 270 in the image 200 of the VR space.

The sensor data acquired by the client device 120 is transmitted to the server device 110. The server device 110 calculates portion information of the avatar 250 based on the received sensor data. Further, after the server device 110 reflects the calculated portion information to the avatar 250 in the image 200 of the VR space, the server device 110 transmits information for a VR space including VR space images to the client devices 130 and 140.

The client device 130 receiving information for a VR space at a time t2 updates visual field images of the user 160 based on VR space images included in the information for a VR space. A visual field image 321 represents a visual field image after the updating. When the user 150 performs a behavior of moving forward in the real space, the avatar 250 of the user 150 approaches in an image 200′ of the VR space. In this manner, the visual field image 321 becomes an image representing a state in which the avatar 250 approaches in the image 200′ of the VR space.

Similarly, the client device 140 receiving information for a VR space at a time t3 updates visual field images of the user 170 based on VR space images included in the information for a VR space. A visual field image 331 represents a visual field image after the updating. When the user 150 performs a behavior of moving forward in the real space, the avatar 250 of the user 150 approaches the avatar 270 of the user 170 in the image 200′ of the VR space. In this manner, the visual field image 331 becomes an image representing a state in which the avatar 250 approaches the avatar 270 in the image 200′ of the VR space.

It is assumed that the user 160 performs a behavior of moving backward (direction of an arrow 302) at a time t4, as illustrated in FIG. 4, in response to the approaching of the image of the avatar 250 in the image 200′ of the VR space. When the client device 130 acquires sensor data obtained by sensing the behaviors of the user 160, the client device 130 updates visual field images of the user 160 in the image 200′ of the VR space based on the sensor data. A visual field image 322 represents a visual field image after the updating. When the user 160 performs a behavior of moving backward in the real space, the avatar 260 of the user 160 is moved away from the avatar 250 of the user 150 even in the image 200′ of the VR space. In this manner, the visual field image 322 becomes an image representing a state in which the avatar 260 is moved away from the avatar 250 in the image 200′ of the VR space.

The sensor data acquired by the client device 130 is transmitted to the server device 110. The server device 110 calculates portion information of the avatar 260 based on the received sensor data.

Similarly, it is assumed that the user 170 performs a behavior of facing the right direction (direction of an arrow 303) in which the avatar 250 adjacent to the avatar 270 in the image 200′ of the VR space is present at a time t5. When the client device 140 acquires sensor data obtained by sensing the behaviors of the user 170, the client device 140 updates visual field images of the user 170 in the image 200′ of the VR space based on the sensor data. A visual field image 332 represents a visual field image after the updating. When the user 170 performs a behavior of facing the right direction in the real space, the right side of the avatar 270 is visually recognized even in the image 200′ of the VR space. In this manner, the visual field image 332 becomes an image representing a state in which the avatar 250 and the avatar 260 are adjacent to each other in the image 200′ of the VR space. Further, the VR space image, in which the behavior of the user 160 at the time t4 is reflected to the movement of the avatar 260 is not displayed on the HMD 143 of the user 170 at the time t5. Therefore, as seen from the visual field image 332, the image of the avatar 260 is an image that the avatar 260 has not moved backward.

The sensor data acquired by the client device 140 is transmitted to the server device 110. The server device 110 calculates portion information of the avatar 270 based on the received sensor data.

Moreover, when a predetermined behavior is performed by the user 150 and the image 200′ of the movement of the avatar 250 in the VR space in response to the behavior is displayed in the HMDs 133 and 143 of the users 160 and 170, updating of the information for a VR space is temporarily stopped. Accordingly, the visual field image which is the same as the visual field image based on the image 200 of the VR space displayed at the time t1 is still displayed in the HMD 123 of the user 150 at a time t6.

As described above, there is a certain degree of time lag between the time (t1) at which the user 150 performs a predetermined behavior in the real space and the time (t4 and t5) at which each of the users 160 and 170 visually recognizes the movement of the avatar 250 of the user 150 based on each visual field image and then responses to the movement.

For this reason, it is difficult to determine that the reactions of the users 160 and 170 are caused by the behavior of the user 150 at the time t1 or caused by another behavior of the user 150 at another time frame among a series of behaviors of the user 150.

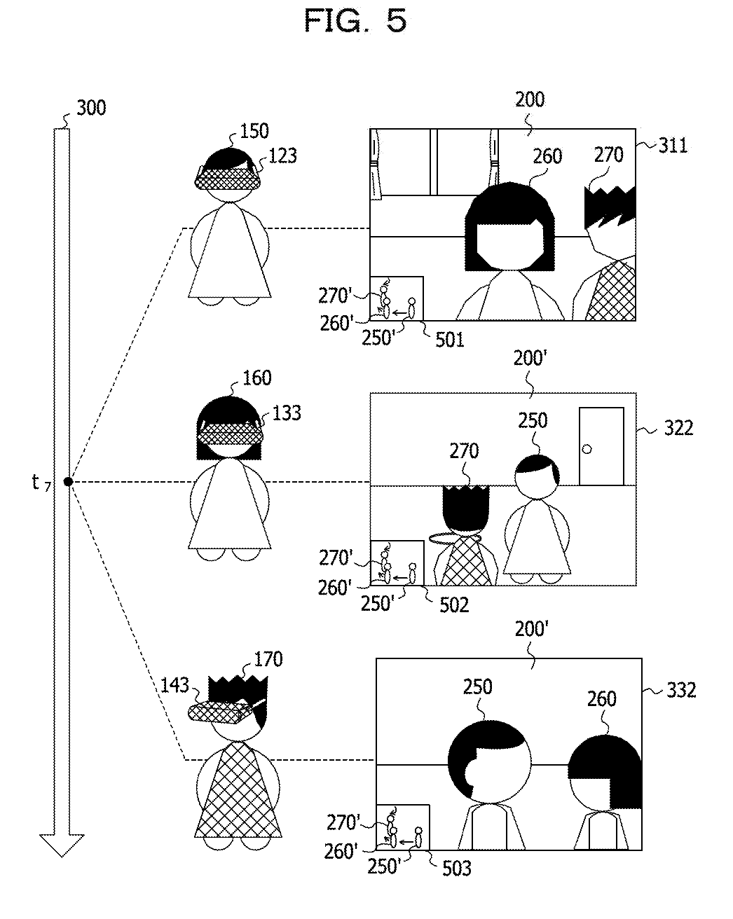

In the first embodiment, time series composed image data in which the behaviors of the users 160 and 170 which are caused by the behavior of the user 150 at the time t1 are collected as the movements of the avatars 250 to 270 is generated by the server device 110. In addition, the time series composed image data is transmitted to the client devices 120, 130, and 140 as the information for time series composed image data. FIG. 5 is a view illustrating an example of a display of the time series composed image data.

As illustrated in FIG. 5, the time series composed image data is displayed in time series composed image data displaying areas 501 to 503 of the visual field images (in the example of FIG. 5, visual field images 311, 322, and 332) of the users 150 to 170. Specifically, the client devices 120, 130, 140 perform control such that the time series composed image data included in the information for time series composed image data, transmitted from the server device 110, is respectively displayed in the time series composed image data displaying areas 501 to 503 at a time t7.

The time series composed image data displayed in the time series composed image data displaying areas 501 to 503 is time series image data including a series of movements of approaching of an avatar 250′ to an avatar 260′, backward moving of the avatar 260′, and turning the face of an avatar 270′ to the right direction.

In the time series composed image data, the avatar 260′ moves backward after the avatar 250′ approaches with a predetermined time difference. The predetermined time difference here indicates a time difference (time difference between t2 and t4) from when the visual field image 321 in a state of the avatar 250 being approached is visually recognized by the user 160 to when the user 160 performs a behavior of moving backward.

Further, in the time series composed image data, the avatar 270′ faces the right direction after the avatar 250′ approaches with a predetermined time difference. The predetermined time difference here indicates a time difference (time difference between t3 and t5) from when the visual field image 331 in a state of the avatar 250 being approached is visually recognized by the user 170 to when the user 170 performs a behavior of facing the right direction.

In this manner, when time series composed image data is displayed, the reactions of the users 160 and 170 caused by the behavior of the user 150 may be realized by the avatars 250′ and 260′ in the VR space as if the reactions of the users 160 and 170 happened in the real space.

Hardware Configuration of Server Device

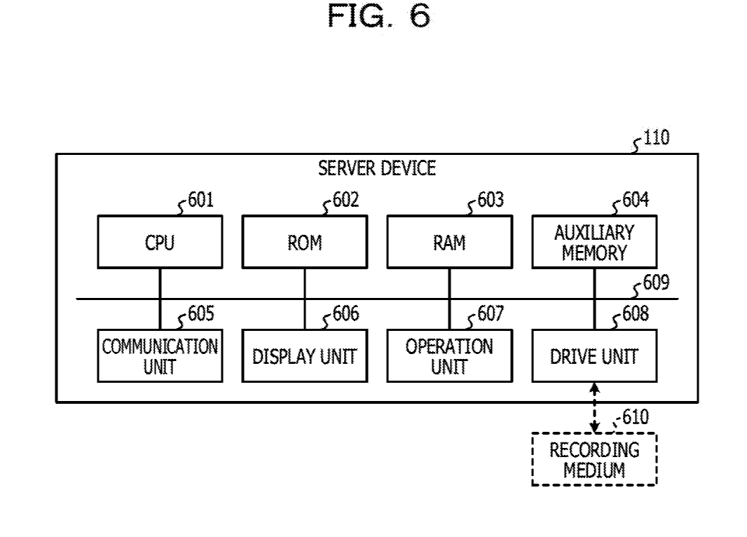

Next, the hardware configuration of the server device 110 will be described. FIG. 6 is a diagram illustrating an example of the hardware configuration of the server device. As illustrated in FIG. 6, the server device 110 includes a central processing unit (CPU) 601, a read only memory (ROM) 602, and a random access memory (RAM) 603. Moreover, the server device 110 includes an auxiliary memory 604, a communication unit 605, a display unit 606, an operation unit 607, and a drive unit 608. Further, respective units of the server devices 110 are connected to each other through a bus 609.

The CPU 601 is a computer that executes various programs (for example, the information providing program for a VR space and the information providing program for time series composed image data) installed in the auxiliary memory 604. The ROM 602 is a non-volatile memory. The ROM 602 functions as a main memory storing data and various programs indispensable for the CPU 601 executing various programs stored in the auxiliary memory 604. Specifically, the ROM 602 stores a booting program such as a basic input/output system (BIOS) or an extensible firmware interface (EFI).

The RAM 603 is a volatile memory such as a dynamic random access memory (DRAM) or a static random access memory (SRAM) and functions as a main memory. The RAM 603 provides a work area expanded when the CPU 601 executes various programs stored in the auxiliary memory 604.

The auxiliary memory 604 stores various programs installed in the server device 110 and information (images (background images of a VR space) of a VR space, avatar images, definition information, or the like) used when the various programs are executed. Moreover, the auxiliary memory 604 stores information (sensor data, logs, or the like) acquired by executing various programs.

The communication unit 605 is a device for communicating with the client devices 120, 130, and 140 to which the server device 110 is connected. The display unit 606 displays various processing results and processing states of the server device 110. The operation unit 607 is used when various instructions are input to the server device 110.

The drive unit 608 is a device for setting a recording medium 610. As the recording medium 610 here, a medium that optically, electrically, or magnetically records information, such as a CD-ROM, a flexible disk, or a magneto-optical disk, may be used. Further, as the recording medium 610, a semiconductor memory that electrically records information, such as a ROM or a flash memory, may be used.

In addition, various programs to be stored in the auxiliary memory 604 are stored by, for example, the distributed recording medium 610 being set by the drive unit 608 and various programs, which are recorded in the recording medium 610, being read out by the drive unit 608. Alternatively, the various programs may be stored by being received via the communication unit 605.

Hardware Configuration of Client Device

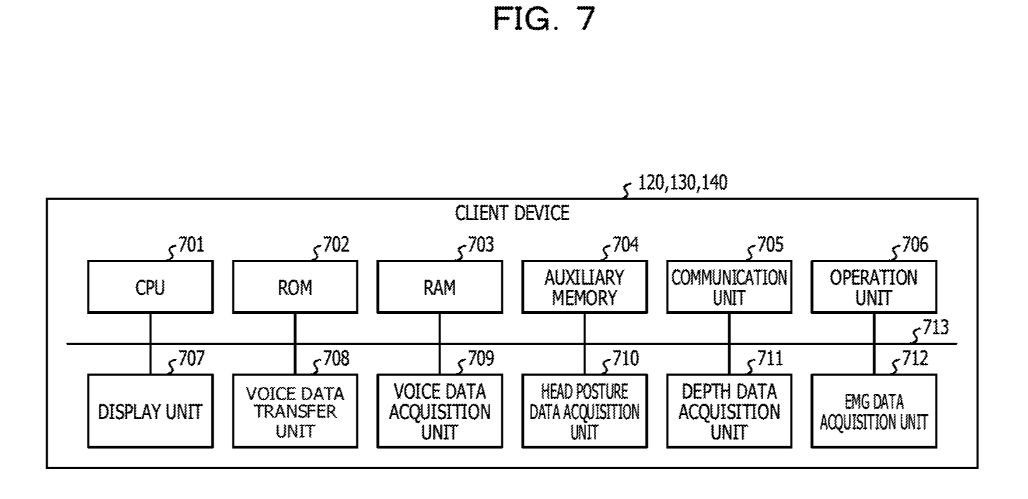

Next, the hardware configurations of the client devices 120, 130, and 140 will be described. FIG. 7 is a diagram illustrating an example of the hardware configuration of a client device. As illustrated in FIG. 7, the client devices 120, 130, and 140 each include a central processing unit (CPU) 701, a read only memory (ROM) 702, and a random access memory (RAM) 703. Moreover, the client devices 120, 130, and 140 each include an auxiliary memory 704, a communication unit 705, an operation unit 706, a display unit 707, a voice data transfer unit 708, and a voice data acquisition unit 709. Further, the client devices 120, 130, and 140 each include a head posture data acquisition unit 710, a depth data acquisition unit 711, and an EMG data acquisition unit 712. Moreover, the respective units are connected to each other via a bus 713.

The CPU 701 is a computer that executes various programs (for example, information providing programs) installed in the auxiliary memory 704. The ROM 702 is a non-volatile memory. The ROM 702 functions as a main memory storing data and various programs indispensable for the CPU 701 executing various programs stored in the auxiliary memory 704. Specifically, the ROM 702 stores a booting program such as a basic input/output system (BIOS) or an extensible firmware interface (EFI).

The RAM 703 is a volatile memory such as a dynamic random access memory (DRAM) or a static random access memory (SRAM) and functions as a main memory. The RAM 703 provides a work area expanded when the CPU 701 executes various programs stored in the auxiliary memory 704.

The auxiliary memory 704 stores various installed programs and information used when the various programs are executed.

The communication unit 705 is a device for communicating with the server device 110 to which the client devices 120, 130, and 140 are connected. The operation unit 706 is used when various instructions are input to the client devices 120, 130, and 140. The display unit 707 displays various processing results and processing states of the client devices 120, 130, and 140.

The voice data transfer unit 708 extracts voice data included in the information for a VR space transmitted by the server device 110 and transmits the voice data to the HMD 123. In this manner, the voice data is output through a speaker included in the HMD 123.

The voice data acquisition unit 709 acquires voice data transmitted by the voice sensor 125 (or a voice sensor 135 or 145). The head posture data acquisition unit 710 acquires head posture data transmitted by the head posture sensor 124 (or a head posture sensor 134 or 144). The depth data acquisition unit 711 acquires depth data transmitted by the depth sensor 122 (or a depth sensor 132 or 142). The EMG data acquisition unit 712 acquires EMG data transmitted by the EMG sensor 126 (or an EMG sensor 136 or 146).

Moreover, the acquired voice data, head posture data, depth data, and EMG data are transmitted, as sensor data, to the server device 110 by the communication unit 705.

Functional Configuration of Client Device

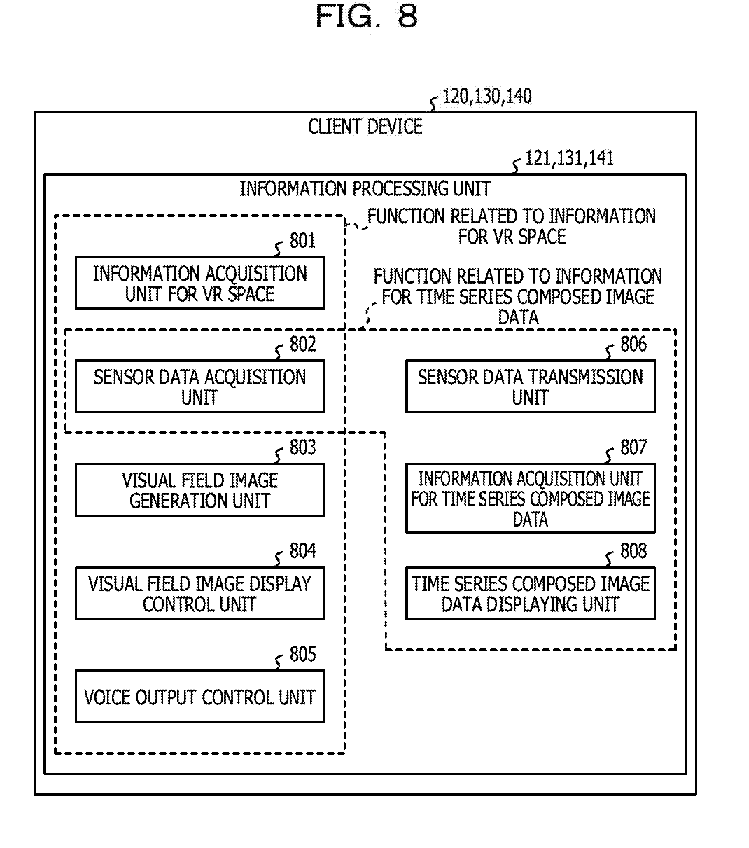

Next, the functional configurations of information processing units 121, 131, and 141 of the client devices 120, 130, and 140 will be described. FIG. 8 is a diagram illustrating an example of the functional configuration of a client device. As illustrated in FIG. 8, the information processing units 121, 131, and 141 of the client devices 120, 130, and 140 include an information acquisition unit 801 for a VR space, a sensor data acquisition unit 802, a visual field image generation unit 803, a visual field image display control unit 804, and a voice output control unit 805. Further, respective units of the information acquisition unit 801 for a VR space to the voice output control unit 805 are functional units used when processing related to information for a VR space is executed.

Moreover, the information processing units 121, 131, and 141 of the client devices 120, 130, and 140 include a sensor data transmission unit 806, an information acquisition unit 807 for time series composed image data, and time series composed image data displaying unit 808. Further, respective units of the sensor data acquisition unit 802 and the sensor data transmission unit 806 to the time series composed image data displaying unit 808 are functional units used when processing related to information for time series composed image data is executed.

The information acquisition unit 801 acquires information for a VR space transmitted by the server device 110 and notifies the visual field image generation unit 803 and the voice output control unit 805 of the acquired information.

The sensor data acquisition unit 802 acquires the head posture data acquired by the head posture data acquisition unit 710 in association with time information related to the sensor data acquisition time. Moreover, the sensor data acquisition unit 802 acquires depth data acquired by the depth data acquisition unit 711 in association with time information related to the sensor data acquisition time. Further, the sensor data acquisition unit 802 acquires EMG data acquired by the EMG data acquisition unit 712 and voice data acquired by the voice data acquisition unit 709 respectively in association with time information related to the sensor data acquisition time.

The sensor data notifies the visual field image generation unit 803 of the acquired head posture data and depth data. Further, the sensor data acquisition unit 802 notifies the sensor data transmission unit 806 of the acquired head posture data, depth data, EMG data, and voice data respectively in association with time information.

The visual field image generation unit 803 generates visual field images of the user 150 at each time frame (or the user 160 or 170) based on the head posture data and the depth data notified by the sensor data acquisition unit 802 and VR space images included in the information for a VR space.

The visual field image display control unit 804 performs control such that the visual field images generated by the visual field image generation unit 803 are displayed on the HMD 123 (or the HMD 133 or 143).

The voice output control unit 805 extracts voice data included in the information for a VR space and controls the voice data to be output from a speaker included in the HMD 123 (or the HMD 133 or 143).

The sensor data transmission unit 806 transmits sensor data notified by the sensor data acquisition unit 802 to the server device 110. At the time of transmitting the sensor data, the sensor data transmission unit 806 transmits the sensor data together with the name of a user utilizing a sensor used for sensing the sensor data. Further, the sensor data transmission unit 806 also transmits an identifier and the like for identifying the client device having acquired the sensed sensor data to the server device 110.

The information acquisition unit 807 for time series composed image data acquires information for time series composed image data transmitted by the server device 110 and notifies the time series composed image data displaying unit 808 of the information.

The time series composed image data displaying unit 808 extracts the time series composed image data included in the information for time series composed image data which is notified by the information acquisition unit 807 for time series composed image data and transmits the extracted time series composed image data to the HMD 123 (or the HMD 133 or 143). Further, the HMD 123 (or the HMD 133 or 143) is controlled such that the displaying of the time series composed image data is started at a displaying start timing instructed by the information for time series composed image data.

Flow of Sensor Data Transmission Processing Executed by Client Device

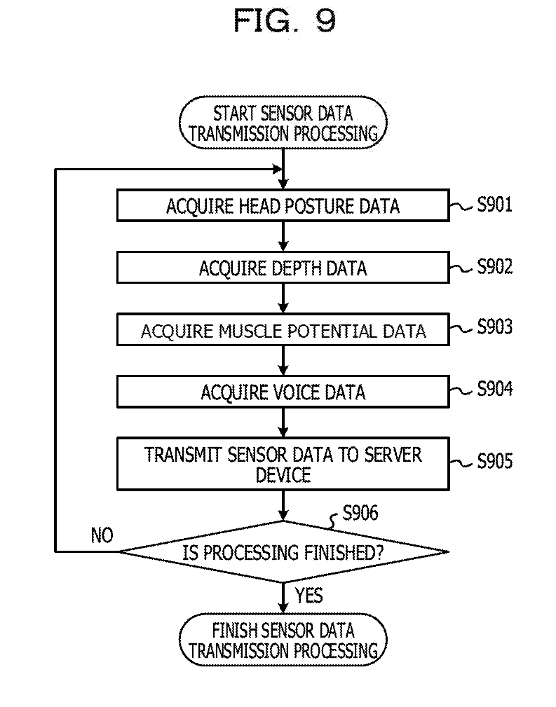

Next, a flow of sensor data transmission processing executed by the client device 120 will be described. FIG. 9 is a flowchart of the sensor data transmission processing executed by a client device.

In Step S901, the sensor data acquisition unit 802 acquires head posture data acquired by the head posture data acquisition unit 710 and notifies the sensor data transmission unit 806 of the head posture data, as sensor data, in association with time information or the like.

In Step S902, the sensor data acquisition unit 802 acquires depth data acquired by the depth data acquisition unit 711 and notifies the sensor data transmission unit 806 of the depth data, as sensor data, in association with time information or the like.

In Step S903, the sensor data acquisition unit 802 acquires EMG data acquired by the EMG data acquisition unit 712 and notifies the sensor data transmission unit 806 of the EMG data, as sensor data, in association with time information or the like.

In Step S904, the sensor data acquisition unit 802 acquires voice data acquired by the voice data acquisition unit 709 and notifies the sensor data transmission unit 806 of the voice data, as sensor data, in association with time information or the like. Further, the order of each process from Steps S901 to S904 is not limited thereto. Alternatively, the processes may be carried out in different order or in parallel with each other.

In Step S905, the sensor data transmission unit 806 transmits the sensor data (including time information and the like) notified by the sensor data acquisition unit 802 to the server device 110.

In Step S906, the sensor data acquisition unit 802 determines whether to finish the sensor data transmission processing. In a case where it is determined not to finish the sensor data transmission processing, the process returns to Step S901, the sensor data transmission processing is continued. Meanwhile, in a case where it is determined to finish the sensor data transmission processing, the sensor data transmission processing is finished.

Flow of VR Space Displaying Processing Executed by Client Device

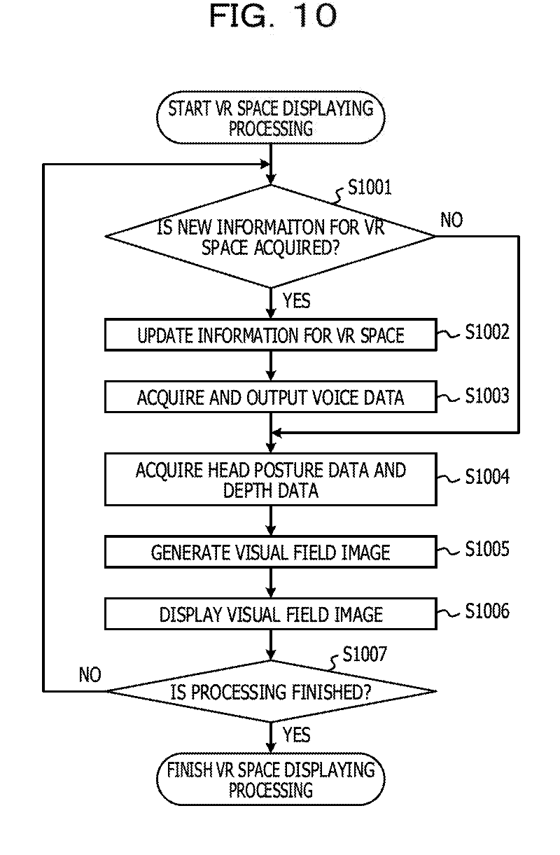

Next, a flow of VR space displaying processing executed by the client devices 120 to 140 will be described. Each VR space displaying processing executed by the client devices 120 to 140 is the same as each other. Therefore, here, the VR space displaying processing executed by the client device 120 will be described. FIG. 10 is a flowchart of the VR space displaying processing executed by a client device.

In Step S1001, the information acquisition unit 801 for a VR space determines whether information for a VR space which is transmitted by the server device 110 is newly acquired. In a case where it is determined that the information has not been newly acquired in Step S1001, the process proceeds to Step S1004.

Meanwhile, in a case where it is determined that the information has been newly acquired in Step S1001, the process proceeds to Step S1002. In Step S1002, the information acquisition unit 801 for a VR space notifies the visual field image generation unit 803 and the voice output control unit 805 of the acquired information for a VR space. In this manner, the information for a VR space held by the visual field image generation unit 803 and the voice output control unit 805 is updated.

In Step S1003, the voice output control unit 805 extracts voice data included in the information for a VR space and outputs the voice data to the HMD 123 through the voice data transfer unit 708.

In Step S1004, the sensor data acquisition unit 802 acquires head posture data acquired by the head posture data acquisition unit 710 and depth data acquired by the depth data acquisition unit 711.

In Step S1005, the visual field image generation unit 803 generates visual field images of the user 150 at a current time based on the head posture data and the depth data acquired in Step S1003 and VR space images included in the currently held information for a VR space. Moreover, the sensor data is used not only for calculation of portion information of each portion of an avatar but also for changing visual field images of a user.

In Step S1006, the visual field image display control unit 804 controls visual field images at a current time which are generated in Step S1004 to be displayed on the HMD 123.

In Step S1007, the information acquisition unit 801 for a VR space determines the presence of an instruction for finishing the VR space displaying processing. In Step S1007, in a case where the information acquisition unit 801 for a VR space determines that there is no instruction for finishing the VR space displaying processing, the process returns to Step S1001. Meanwhile, in Step S1007, in a case where the information acquisition unit 801 for a VR space determines that an instruction for finishing the VR space displaying processing is input, the VR space displaying processing is finished.

Flow of Time Series Composed Image Data Displaying Processing Executed by Client Device

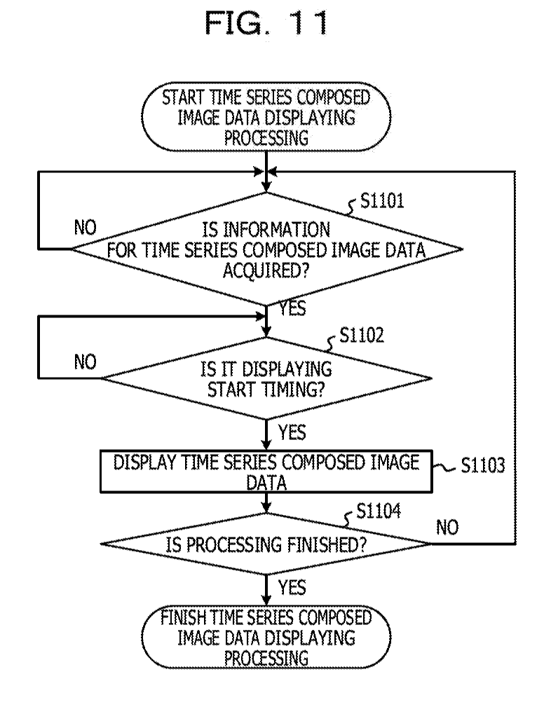

Next, a flow of time series composed image data displaying processing executed by the client devices 120 to 140 will be described. Each time series composed image data displaying processing executed by the client devices 120 to 140 is the same as each other. Therefore, here, the time series composed image data displaying processing executed by the client device 120 will be described. FIG. 11 is a flowchart of the time series composed image data displaying processing executed by a client device.

In Step S1101, the information acquisition unit 807 for time series composed image data determines whether information for time series composed image data is acquired by the server device 110. In Step S1101, in a case where it is determined that the information for time series composed image data has not been acquired, the information acquisition unit 807 for time series composed image data waits until the information for time series composed image data is acquired.

Meanwhile, in Step S1101, in a case where the information acquisition unit 807 for time series composed image data determines that information for time series composed image data is acquired, the process proceeds to Step S1102. In Step S1102, the time series composed image data displaying unit 808 determines whether the current time is the displaying start timing of time series composed image data included in the information for time series composed image data.

In Step S1102, in a case where it is determined that the current time is not the displaying start timing of the time series composed image data, the time series composed image data displaying unit 808 waits until the current time becomes the displaying start timing. Meanwhile, in Step S1102, in a case where it is determined that the current time is the displaying start timing of the time series composed image data, the process proceeds to Step S1103.

In Step S1103, the time series composed image data displaying unit 808 controls the time series composed image data to be displayed on the HMD 123.

In Step S1104, the information acquisition unit 807 for time series composed image data determines whether to finish the time series composed image data displaying processing. In Step S1104, in a case where it is determined not to finish the time series composed image data displaying processing, the process returns to Step S1101, the time series composed image data displaying processing is continued. Meanwhile, in a case where it is determined to finish the time series composed image data displaying processing in Step S1104, the time series composed image data displaying processing is finished.

Functional Configuration of Server Device (Information Providing Unit for VR Space)

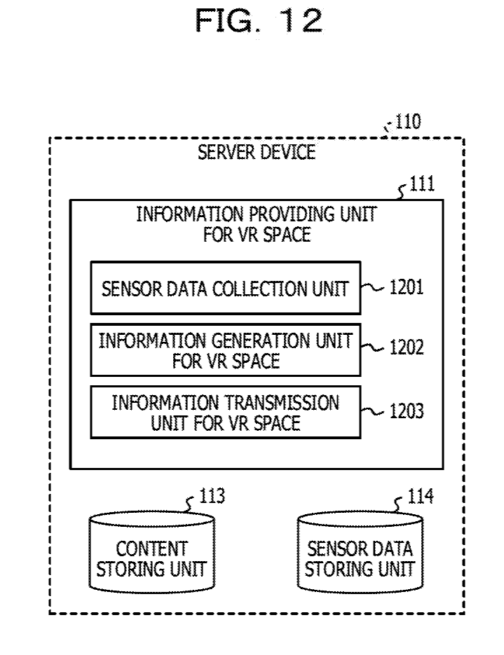

Next, the functional configuration of the server device 110 will be described. FIG. 12 is a first diagram illustrating an example of the functional configuration of the server device and is also a diagram illustrating the functional configuration of the information providing unit 111 for a VR space.

As illustrated in FIG. 12, the information providing unit 111 for a VR space of the server device 110 includes a sensor data collection unit 1201, an information generation unit 1202 for a VR space, and an information transmission unit 1203 for a VR space.

The sensor data collection unit 1201 collects sensor data transmitted by each of the client devices 120, 130, and 140 and stores the sensor data in the sensor data storing unit 114. In addition, the sensor data collection unit 1201 notifies the information generation unit 1202 for a VR space of the collected sensor data.

The information generation unit 1202 for a VR space reads out VR space images (background images of a VR space) from the content storing unit 113. In addition, the information generation unit 1202 for a VR space reads out avatar images corresponding to respective users from the content storing unit 113 and specifies avatars to be allocated in VR space images (background images of a VR space). Further, the information generation unit 1202 for a VR space calculates portion information of each portion of avatars based on the sensor data collected by the sensor data collection unit 1201, allocates the avatars in VR space images (background images of a VR space), and extracts voice data from the sensor data. In this manner, since avatars move and utter in response to behaviors of each user, the information generation unit 1202 for a VR space generates voice and images of the VR space at each time frame.

The information transmission unit 1203 for a VR space transmits the information for a VR space which includes images and voice of the VR space, generated by the information generation unit 1202 for a VR space, to a client device other than the client device serving as a transmission source that transmits sensor data.

Sensor data to be stored by information providing unit for VR space

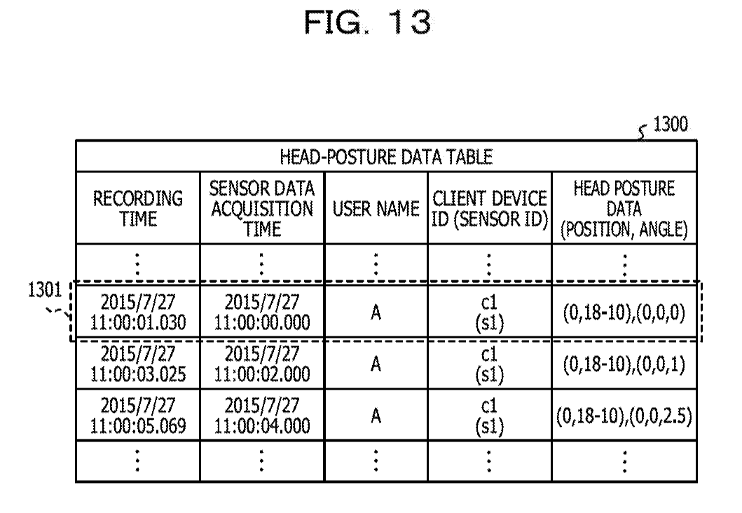

Next, in sensor data stored in the sensor data storing unit 114, sensor data from which voice data is excluded (head posture data, depth data, and EMG data) will be described with reference to FIGS. 13 to 15. In the description below, the description of voice data is omitted and head posture data, depth data, and EMG data will be described as sensor data (in this case, it is assumed that the voice data is treated in the same manner as other pieces of sensor data).

Moreover, in the description (positions and rotation angles) below, positions are coordinates uniquely determined with respect to the XYZ axes in the VR space and angles indicate rotation degrees with respect to the XYZ axes in the VR space.

(1) Head Posture Data

FIG. 13 is a diagram illustrating an example of a head posture data table. As illustrated in FIG. 13, a head posture data table 1300 includes, as items of information, “recording time”, “sensor data acquisition time”, “user name”, “client device ID”, and “head posture data (positions and rotation angles)”.

The time of the head posture data being stored in the sensor data storing unit 114 is recorded in the “recording time”. The time of the head posture data being acquired by the sensor data acquisition unit 802 is recorded in the “sensor data acquisition time”. When the sensor data transmission unit 806 transmits head posture data, as the sensor data, to the server device 110, the sensor data transmission unit 806 also transmits time information related to the sensor time acquisition time of acquiring the head posture data.

The user names of users utilizing a head posture sensor are recorded in the “user name”. When the sensor data transmission unit 806 transmits head posture data, as the sensor data, to the server device 110, the sensor data transmission unit 806 also transmits the user names of users utilizing a head posture sensor.

Identifiers for identifying client devices that transmit the sensor data including head posture data are recorded in the “client device ID”. When the sensor data transmission unit 806 transmits sensor data to the server device 110, the sensor data transmission unit 806 also transmits the identifiers for client devices. Further, the sensor data transmission unit 806 may transmit an identifier for identifying a head posture sensor in addition to the identifiers for identifying the client devices. In this case, the identifier for identifying a head posture sensor is also recorded in the “client device ID” in addition to the identifiers for identifying the client devices.

Position data and rotation angle data, which are included in head posture data, are recorded in the “head posture data (positions and rotation angles)”. Specifically, the head posture data is calculated as positions with respect to the XYZ axes and rotation angles with respect to the XYZ axes in the VR space and then the results are chronologically recorded.

An example of the data row 1301 of FIG. 13 represents that the user 150 having a user name of “user A” is sensed by the head posture sensor 124 identified by a sensor ID of “s1” at 11:00:00:000 on Jul. 27, 2015 and then the head posture data is acquired. Further, the example of the data row 1301 represents that the head posture data is calculated as a position and a rotation angle in the VR space and the result of ((position), (rotation angle)) is “((0, 18,-18), (0, 0, 0))”. The example of the data row 1301 represents that the head posture data is transmitted by the client device 120 having a client device ID of “c1” and the head posture data is stored in the head posture data table 1300 at 11:00:01:030 on Jul. 27, 2015.

(2) Depth Data File

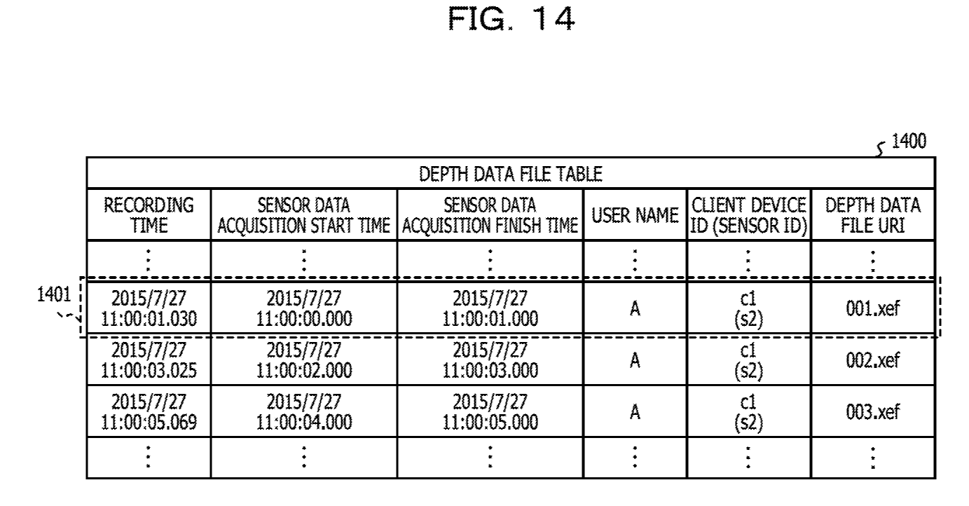

FIG. 14 is a diagram illustrating an example of a depth data file table. As illustrated in FIG. 14, a depth data file table 1400 includes, as items of information, “recording time”, “sensor data acquisition start time”, “sensor data acquisition finish time”, “user name”, “client device ID”, and “depth data file URI”.

The time of the depth data file being stored in the depth data file table 1400 is recorded in the “recording time”. The sensor data acquisition time (for example, the start time of a predetermined time) at which initial depth data in the depth data file formed from a plurality of depth data groups acquired during a predetermined time is acquired is recorded in the “sensor data acquisition start time”. The sensor data acquisition time (for example, the finish time of a predetermined time) at which final depth data in the depth data file formed from a plurality of depth data groups acquired during a predetermined time is acquired is recorded in the “sensor data acquisition finish time”. When the sensor data transmission unit 806 transmits the depth data file, as the sensor data, to the server device 110, the sensor data transmission unit 806 also transmits time information representing the sensor data acquisition time in which each depth data group is acquired.

The user names of users utilizing a depth sensor are recorded in the “user name”. When the sensor data transmission unit 806 transmits the depth data file, as the sensor data, to the server device 110, the sensor data transmission unit 806 also transmits the user names of users utilizing a depth sensor.

Identifiers for identifying client devices that transmit the sensor data including the depth data file are recorded in the “client device ID”. When the sensor data transmission unit 806 transmits sensor data to the server device 110, the sensor data transmission unit 806 also transmits the identifiers for client devices. Further, the sensor data transmission unit 806 may transmit an identifier for identifying a depth sensor in addition to the identifiers for identifying the client devices. In this case, the identifier for identifying a depth sensor is also recorded in the “client device ID” in addition to the identifiers for identifying the client devices.

A uniform resource identifier (URI) representing a storage location of the depth data file and the file name are recorded in the “depth data file URI” (URI is condensed in FIG. 14).

An example of the data row 1401 of FIG. 14 represents that the depth data file having a file name of “001.xef” is stored in the depth data file table 1400 as a depth data file. Further, the example of the data row 1401 of FIG. 14 represents that the depth data file includes depth data acquired at “11:00:00:000 on Jul. 27, 2015” to depth data acquired at “11:00:01:000 on Jul. 27, 2015”. Further, the example of the data row 1401 represents that the user 150 having a user name of “user A” is sensed by the depth sensor 122 identified by a sensor ID of “s1” and then the depth data file is acquired. In addition, the example of the data row 1401 represents that the depth data file is transmitted by the client device 120 having a client device ID of “c1” and the depth data file is stored in the depth data file table 1400 at 11:00:01:030 on Jul. 27, 2015.

(3) EMG Data

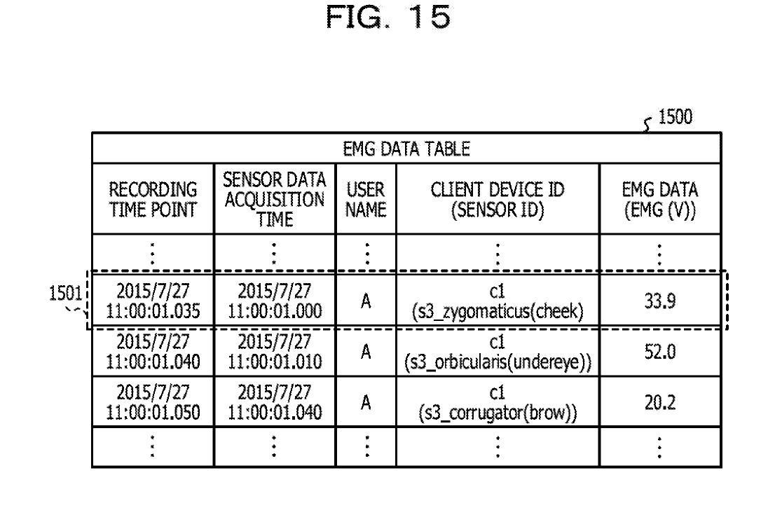

FIG. 15 is a diagram illustrating an example of an EMG data table. As illustrated in FIG. 15, an EMG data table 1500 includes, as items of information, “recording time”, “sensor data acquisition time”, “user name”, “client device ID”, and “EMG data (EMG (μV ))”.

The time of the EMG data being stored in the EMG data table 1500 is recorded in the “recording time”. The time of the EMG data being acquired by the sensor data acquisition unit 802 is recorded in the “sensor data acquisition time”. When the sensor data transmission unit 806 transmits EMG data, as the sensor data, to the server device 110, the sensor data transmission unit 806 also transmits time information related to the sensor time acquisition time of acquiring the EMG data.

The user names of users utilizing an EMG sensor are recorded in the “user name”. When the sensor data transmission unit 806 transmits EMG data to the server device 110, the sensor data transmission unit 806 also transmits the user names of users utilizing an EMG sensor.

Identifiers for identifying client devices that transmit the sensor data including EMG data are recorded in the “client device ID”. When the sensor data transmission unit 806 transmits sensor data to the server device 110, the sensor data transmission unit 806 also transmits the identifiers for client devices in association with the sensor data. Further, the sensor data transmission unit 806 may transmit an identifier for identifying an EMG sensor in addition to the identifiers for identifying the client devices. Particularly, in a case where plural kinds of EMG sensors are distributed according to sensed portions, identifiers for identifying each EMG sensor may be transmitted. In this case, the identifiers for identifying each EMG sensor are also recorded in the “client device ID” in addition to the identifiers for identifying the client devices.

Values of EMG data are recorded in the “EMG data (EMG (μV ))”.

An example of the data row 1501 of FIG. 15 represents that the user 150 having a user name of “user A” is sensed at 11:00:01:000 on Jul. 27, 2015. Further, the example of the data row 1501 represents that an EMG sensor identified by the sensor ID of “s3_zygomaticus (cheek)” is sensed. Further, the example of the data row 1501 represents that the sensor data acquisition unit 802 acquires EMG (μV) of “33.9” as the EMG data. Furthermore, the example of the data row 1501 represents that the EMG data is transmitted by the client device 120 having a client device ID of “c1” and the EMG data is stored in the EMG data table 1500 at 11:00:01:035 on Jul. 27, 2015.

Flow of Information Providing Processing for VR Space Executed by Information Providing Unit for VR Space

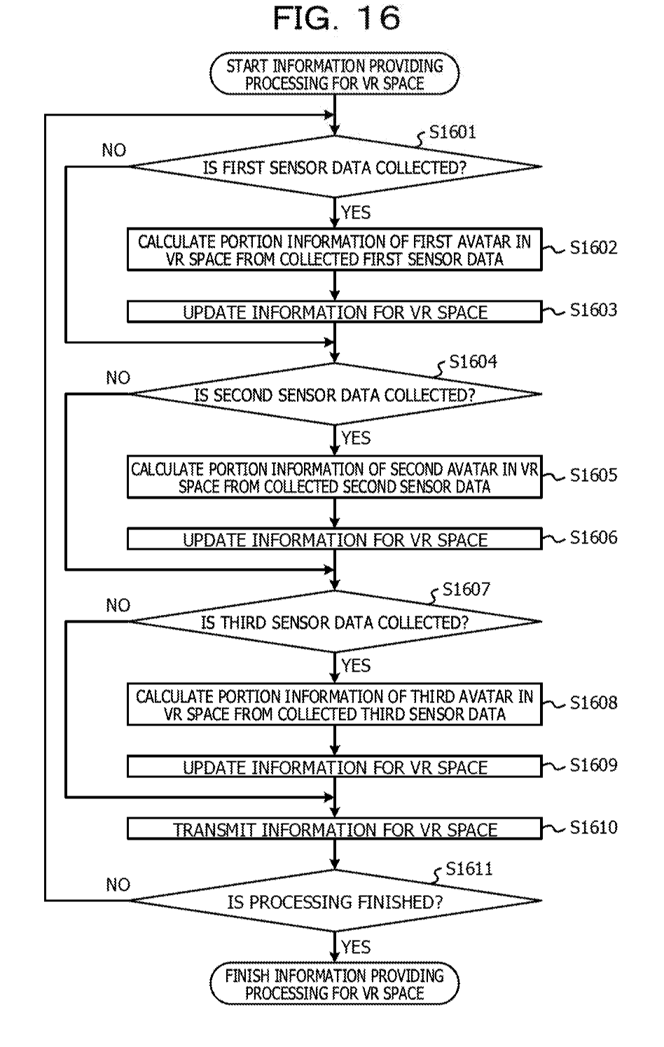

Next, a flow of the information providing processing for a VR space which is executed by the information providing unit 111 for a VR space of the server device 110 will be described. FIG. 16 is a flowchart of the information providing processing for a VR space which is executed by the server device.

In Step S1601, the sensor data collection unit 1201 determines whether sensor data (first sensor data) is collected by the client device 120. In Step S1601, in a case where it is determined that the first sensor data has not been collected, the process proceeds to Step S1604.

Meanwhile, in a case where it is determined that the first sensor data has been collected in Step S1601, the process proceeds to Step S1602. In Step S1602, the sensor data collection unit 1201 stores the collected first sensor data in the sensor data storing unit 114. Further, the information generation unit 1202 for a VR space calculates portion information of each portion of the avatar 250 (first avatar) in the VR space based on the collected first sensor data.

In Step S1603, the information generation unit 1202 for a VR space generates the first avatar reflecting the calculated portion information. Further, the information generation unit 1202 for a VR space updates information for a VR space using the generated first avatar.

In Step S1604, the sensor data collection unit 1201 determines whether sensor data (second sensor data) is collected by the client device 130. In Step S1604, in a case where it is determined that the second sensor data has not been collected, the process proceeds to Step S1607.

Meanwhile, in a case where it is determined that the second sensor data has been collected in Step S1604, the process proceeds to Step S1605. In Step S1605, the sensor data collection unit 1201 stores the collected second sensor data in the sensor data storing unit 114. Further, the information generation unit 1202 for a VR space calculates portion information of each portion of the avatar 260 (second avatar) in the VR space based on the collected second sensor data.

In Step S1606, the information generation unit 1202 for a VR space generates the second avatar reflecting the calculated portion information. Further, the information generation unit 1202 for a VR space updates information for a VR space using the generated second avatar.

In Step S1607, the sensor data collection unit 1201 determines whether sensor data (third sensor data) is collected by the client device 140. In Step S1607, in a case where it is determined that the third sensor data has not been collected, the process proceeds to Step S1610.

Meanwhile, in a case where it is determined that the third sensor data has been collected in Step S1607, the process proceeds to Step S1608. In Step S1608, the sensor data collection unit 1201 stores the collected third sensor data in the sensor data storing unit 114. Further, the information generation unit 1202 for a VR space calculates portion information of each portion of the avatar 270 (third avatar) in the VR space based on the collected third sensor data

In Step S1609, the information generation unit 1202 for a VR space generates the third avatar reflecting the calculated portion information. Further, the information generation unit 1202 for a VR space updates information for a VR space using the generated third avatar.

In Step S1610, the information transmission unit 1203 for a VR space transmits updated information for a VR space. In a case where the information for a VR space is updated based on the sensor data (first sensor data) transmitted by the client device 120, the information transmission unit 1203 for a VR space transmits the updated information for a VR space to the client devices 130 and 140. Further, in a case where the information for a VR space is updated based on the sensor data (second sensor data) transmitted by the client device 130, the information transmission unit 1203 for a VR space transmits the updated information for a VR space to the client devices 120 and 140. Further, in a case where the information for a VR space is updated based on the sensor data (third sensor data) transmitted by the client device 140, the information transmission unit 1203 for a VR space transmits the updated information for a VR space to the client devices 120 and 130.

In Step S1611, the sensor data collection unit 1201 determines whether to finish the information providing processing for a VR space. In a case where it is determined not to finish the information providing processing for a VR space in Step S1611, the process returns to Step S1601, and the information providing processing for a VR space is continued. Meanwhile, in a case where it is determined to finish the information providing processing for a VR space in Step S1611, the information providing processing for a VR space is finished.

Functional Configuration of Server Device (Information Providing Unit for Time Series Composed Image Data)

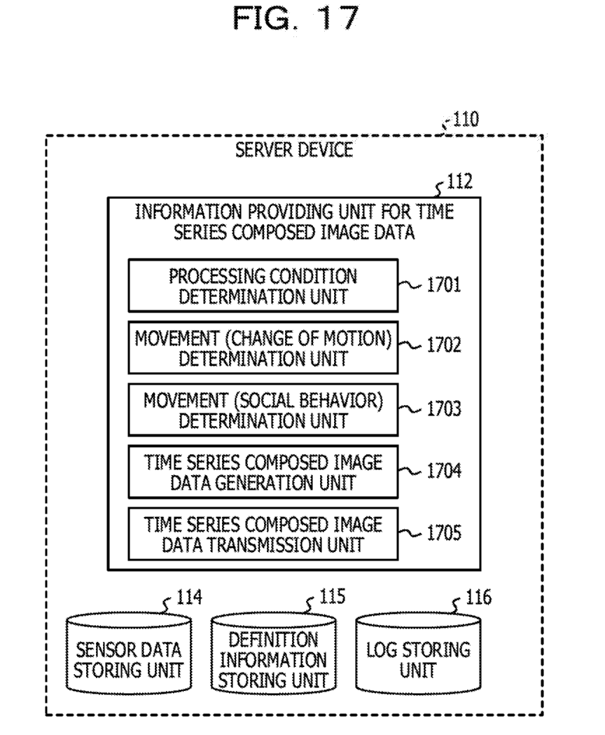

Next, among the functional configurations of the server device 110, the functional configuration of the information providing unit 112 for time series composed image data will be described. FIG. 17 is a second diagram illustrating an example of the functional configuration of the server device and is also a diagram illustrating the functional configuration of the information providing unit 112 for time series composed image data.

As illustrated in FIG. 17, the information providing unit 112 for time series composed image data of the server device 110 includes a processing condition determination unit 1701, a movement (change of motion) determination unit 1702, a movement (social behavior) determination unit 1703, time series composed image data generation unit 1704, and time series composed image data transmission unit 1705.

The processing condition determination unit 1701 determines whether the condition for the movement (change of motion) determination unit 1702 to start processing is satisfied. In the first embodiment, when a predetermined amount of sensor data is stored in the sensor data storing unit 114, the processing condition determination unit 1701 determines that the condition for the movement (change of motion) determination unit 1702 to start processing is satisfied and notifies the movement (change of motion) determination unit 1702 of the result.

When a predetermined amount of sensor data is stored in the sensor data storing unit 114 and the movement (change of motion) determination unit 1702 is notified of the result by the processing condition determination unit 1701, the movement (change of motion) determination unit 1702 acquires portion information calculated by the information generation unit 1202 for a VR space based on the predetermined amount of sensor data. In addition, the portion information acquired at this time is portion information for a plurality of time frames. Further, the movement (change of motion) determination unit 1702 determines whether the acquired portion information is changed more than a predetermined amount.

The movement (change of motion) determination unit 1702 determines whether the portion information is changed more than a predetermined amount by comparing threshold values defined by definition information stored in the definition information storing unit 115 with portion information acquired by the information generation unit 1202 for a VR space. Moreover, when it is determined that the portion information is changed more than a predetermined amount, the movement (change of motion) determination unit 1702 determines that each portion of an avatar is moved more than a predetermined amount and then determines the type of movement. Further, the movement (change of motion) determination unit 1702 stores the determination result or the like of the type of movement in the “movement type determination log table” of the log storing unit 116 by newly adding a data row thereto.

In a case where the movement (change of motion) determination unit 1702 determines that the portion information of each portion of an avatar is changed more than a predetermined amount, the movement (social behavior) determination unit 1703 determines the type of movement with respect to other avatars based on a part of the predetermined amount of sensor data.

The movement (social behavior) determination unit 1703 stores the determination results and the time ranges (referred to as determination time (start) and determination time (finish)) of sensor data used for the determination in the “movement type determination log table with respect to another avatar” of the log storing unit 116. The movement (social behavior) determination unit 1703 stores the determination result or the like in the “movement type determination log table with respect to another avatar” by newly adding a data row thereto.

In this manner, when the movement (change of motion) determination unit 1702 determines that portion information of each portion of an avatar is changed more than a predetermined amount, the movement (social behavior) determination unit 1703 determines the type of movement with respect to another avatar.

Accordingly, the determination time (start) in the time ranges of sensor data used for determining the type of movement with respect to another avatar is the sensor data acquisition time of sensor data used when the movement (change of motion) determination unit 1702 determines that the portion information is changed more than a predetermined amount. In this case, the determination time (start) is not limited thereto and the movement (social behavior) determination unit 1703 may determine the type of movement with respect to another avatar using the sensor data acquired before the acquisition time.

When a new data row is added to the “movement type determination log table with respect to another avatar” of the log storing unit 116 by the movement (social behavior) determination unit 1703, the time series composed image data generation unit 1704 determines that an action event has occurred. When a new data row is added to the “movement type determination log table with respect to another avatar” of the log storing unit 116 after the time series composed image data generation unit 1704 determines that an action event has occurred, the time series composed image data generation unit 1704 determines that a reaction event has occurred.

The time series composed image data generation unit 1704 extracts the “determination time (start)” and “determination time (finish)” of the data row newly added to the “movement type determination log table with respect to another avatar” of the log storing unit 116, which is the data row stored when an action event has occurred. Further, the time series composed image data generation unit 1704 generates time series image data used for generation of time series composed image data based on the sensor data acquired in a time range of the extracted “determination time (start)” to “determination time (finish)”. Further, the time series composed image data generation unit 1704 extracts the “determination time (start)” and “determination time (finish)” of the data row stored when a reaction event has occurred. Moreover, the time series composed image data generation unit 1704 generates time series image data used for generation of time series composed image data based on the sensor data acquired in a time range of the extracted “determination time (start)” to “determination time (finish)”.

In this manner, for example, it is possible to synthesize time series image data of a VR space to which the movement of the avatar 250 that causes an action event is reflected and time series image data of a VR space to which the movement of the avatar 260 that causes a reaction event is reflected.

Further, the time series composed image data generation unit 1704 performs synthesis of the image group of a VR space to which the movement of the avatar 250 that causes an action event is reflected according to a time difference between the time at which the image group is displayed on the HMD 133 of the user 160 and the time at which the user 160 has responded. That is, the time series composed image data generation unit 1704 performs synthesis according to a time difference between the output timing and the reaction timing. Further, the reaction timing here equivalents to the “determination time (start)” which is a detection timing at which the reaction of the user 160 is detected.

Similarly, the time series composed image data generation unit 1704 can synthesize time series image data of a VR space to which the movement of the avatar 250 that causes an action event is reflected and time series image data of a VR space to which the movement of the avatar 270 that causes a reaction event is reflected.

Further, the time series composed image data generation unit 1704 performs synthesis of the image group of a VR space to which the movement of the avatar 250 that causes an action event is reflected according to a time difference between the time at which the image group is displayed on the HMD 143 of the user 170 and the time at which the user 170 has responded. That is, the time series composed image data generation unit 1704 performs synthesis according to a time difference between the output timing and the reaction timing. Further, the reaction timing here equivalents to the “determination time (start)” which is a detection timing at which the reaction of the user 170 is detected.

In this manner, the time series composed image data generation unit 1704 generates time series composed image data to which the movements of the avatars 250, 260, and 270 are reflected with a predetermined time difference.

The time series composed image data transmission unit 1705 transmits information for time series composed image data, which includes time series composed image data generated by the time series composed image data generation unit 1704, to the client devices 120, 130, and 140.

Description of Type of Movement to be Determined by Information Providing Unit for Time Series Composed Image Data

Next, the type of movement to be determined by the movement (change of motion) determination unit 1702 will be described. The movements of an avatar include movements of the entire body of an avatar, movements in a part of the body of an avatar, and movements of facial expressions in a part (face) of the body of an avatar.

The movements of the entire body of an avatar include movements of an avatar moving forward or backward and to the left or right side and movements of changing the orientation of the entire body of an avatar. The movements of an avatar moving forward or backward and to the left or right side can be expressed as a change in coordinates of the central position of an avatar. Further, the movements of changing the orientation of the entire body to the right or left side without changing the position like the time of changing the travelling direction of an avatar can be expressed as a change of a rotation angle in the vicinity of an axis (Y-axis) extending in a direction perpendicular to the floor surface.

The movements in a part of the body of an avatar include movements of tilting the upper body of an avatar forward or backward and movements of changing the orientation of the upper body of an avatar to the left or right side. Further, the movements in a part of the body of an avatar include movements of changing the orientation of the face of an avatar upward or downward and movements of changing the orientation of the face of an avatar to the left or right side.

Among these, the movements of changing the orientation of the upper body of an avatar forward or backward and the movements of changing the orientation of the upper body of an avatar to the left or right side can be expressed as a change (change of “Bone_Chest”) of an rotation angle around axes in the triaxial directions using the waist position of an avatar as an origin. Similarly, the movements of changing the orientation of the face of an avatar upward or downward and the movements of changing the orientation of the face of an avatar to the left or right side can be expressed as a change (change of “Bone_Head”) of an rotation angle around axes in the triaxial directions using the face position of an avatar as an origin.

The movements of changing the facial expressions in a part (face) of an avatar include movements of the eyegaze of an avatar to the upper or lower direction and to the left or right direction, movements of the corner of the mouth of an avatar to the upper or lower side, and movements of changing the rotation angle of eyebrows of an avatar. These movements can be expressed as a change (for example, change of “Shape_Mouth”) in a state of positions of a plurality of point groups in the face of an avatar or a plane (for example, corresponding to the skin of lips) surrounded by the positions.

In addition, the above-described expression methods related to the movements of an avatar are merely examples and the movements of an avatar may be expressed using other expression methods. In the first embodiment, the portion information of each portion of an avatar includes the above-described “Bone_chest”, “Bone_Head”, and “Shape_Mouth”.

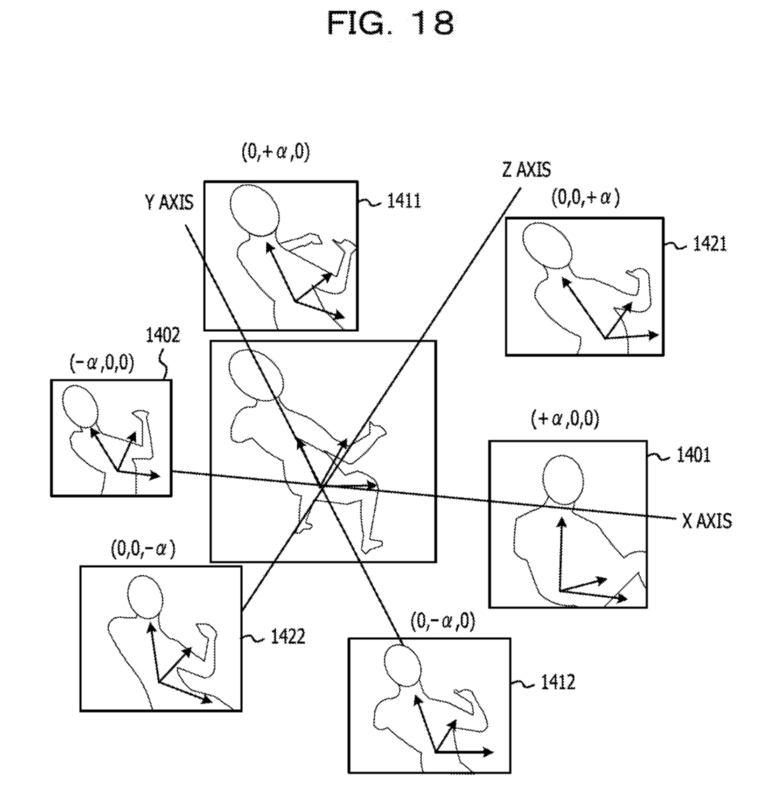

FIG. 18 is a view illustrating an example of movements of an avatar in the VR space. In FIG. 18, the movements of changing the orientation of the upper body of an avatar forward or backward and the movements of changing the orientation of the upper body of an avatar to the left or right side are expressed as a change (change of “Bone_Chest”) of an rotation angle around axes in the triaxial directions using the waist position of an avatar as an origin.

Specifically, the movements are expressed as a rotation of a skeleton allocated in the waist position of an avatar at the time when the XYZ axes in the VR space each correspond to the horizontal direction, the vertical direction, and the front-back direction of an avatar.

In FIG. 18, an image 1801 illustrates the posture of an avatar in a case where the avatar is rotated at a +α degree on the x-axis and an image 1802 illustrates the posture of the avatar in a case where the avatar is rotated at a −α degree on the x-axis.

Further, an image 1811 illustrates the posture of the avatar in a case where the avatar is rotated at a +α degree on the y-axis and an image 1812 illustrates the posture of the avatar in a case where the avatar is rotated at a −α degree on the y-axis.

Furthermore, an image 1821 illustrates the posture of the avatar in a case where the avatar is rotated at a +α degree on the z-axis and an image 1822 illustrates the posture of the avatar in a case where the avatar is rotated at a −α degree on the z-axis.

Definition Information Being Referred to When Type of Movement is Determined

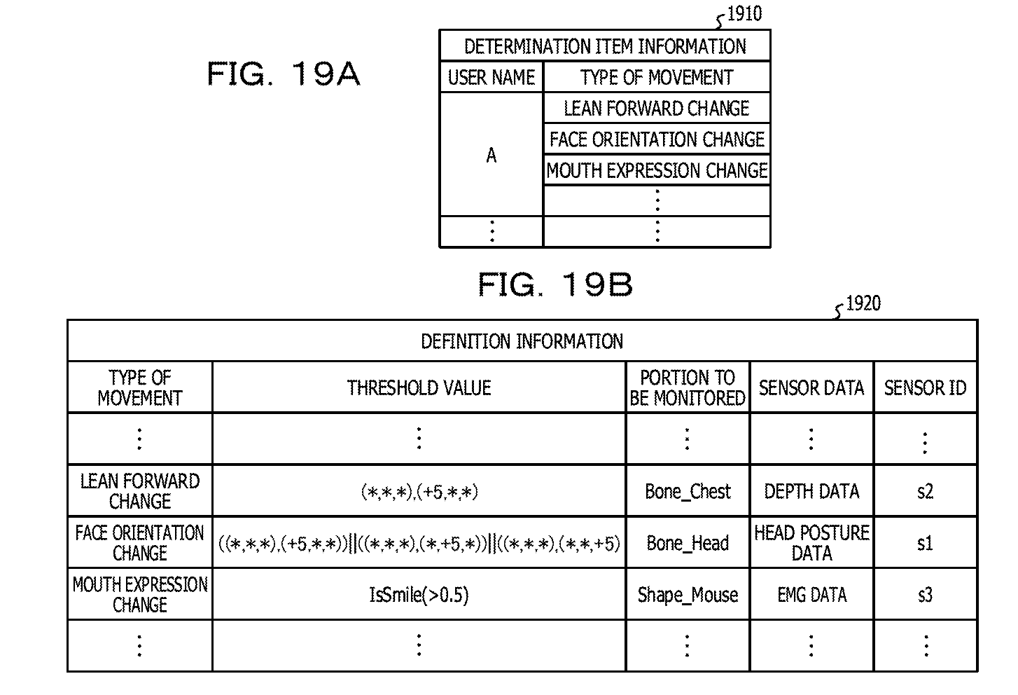

Next, definition information which is referred to when stored in the definition information storing unit 115 and the movement (change of motion) determination unit 1702 determines the type of movement will be described. FIGS. 19A and 19B are diagrams illustrating definition information for determining the type of movement of an avatar, among the definition information stored in the definition information storing unit. As illustrated in FIGS. 19A and 19B, determination item information 1910 and determination threshold information 1920 are included in the definition information for determining the type of movement of an avatar.

As illustrated in FIG. 19A, the determination item information 1910 defines the “type of movement” to be determined for each user. This is because sensor data which can be acquired is occasionally different for each client device used by a user and the “type of movement” which can be determined becomes different in a case where the sensor data which can be acquired is different.

In the example of FIG. 19A, in a case where the user name is the “user A”, it can be determined that the “type of movement” includes at least lean forward change, face orientation change, and mouth expression change.

Moreover, as illustrated in FIG. 19B, the determination threshold information 1920 defines “sensor data” used for determination of the type of each movement. Further, the determination threshold information 1920 defines a “portion to be monitored” which is to be monitored to determine the presence of a change, in the portion information of each portion of an avatar which is calculated based on the sensor data. Further, the determination threshold information 1920 defines the condition (“threshold”) for determining that there has been a change among portion information of each portion to be monitored. In addition, the determination threshold information 1920 defines the “type of movement” to be determined in a case of determining that there has been a change in portion information of each portion to be monitored.

For example, the movement (change of motion) determination unit 1702 monitors “Bone_Chest” among the portion information to be calculated based on depth data. When the portion value of “Bone_Chest” which is a portion to be monitored is detected to be rotated at a +5 degree or greater in the vicinity of the X-axis, the movement (change of motion) determination unit 1702 determines that the “lean forward change” has occurred.

For example, the movement (change of motion) determination unit 1702 monitors “Bone_Head” among the portion information to be calculated based on head posture data. When the portion value of “Bone_Head” which is a portion to be monitored is detected to be rotated at a +5 degree or greater in the vicinity of any of the axes, the movement (change of motion) determination unit 1702 determines that the “face orientation change” has occurred.

In addition, the movement (change of motion) determination unit 1702 monitors “Shape_Mouth” in the portion information calculated based on the EMG data. Specifically, the movement (change of motion) determination unit 1702 monitors a parameter (“IsSmile”) indicating the degree of smile which is calculated based on the portion value of the “Shape_Mouth”. In a case where “IsSmile” is 0, the parameter (“IsSmile”) indicating the degree of smile represents a position of a point group in a state in which the mouth is closed. In a case where “IsSmile” is 1, the parameter (“IsSmile”) represents a position of a point group in a state in which the mouth is wide open. When it is detected that the parameter (“IsSmile”) calculated from “Shape_Mouth” is greater than 0.5, the movement (change of motion) determination unit 1702 determines that the “mouth expression change” has occurred.

Definition Information Used When Type of Movement With Respect to Another Avatar is Determined

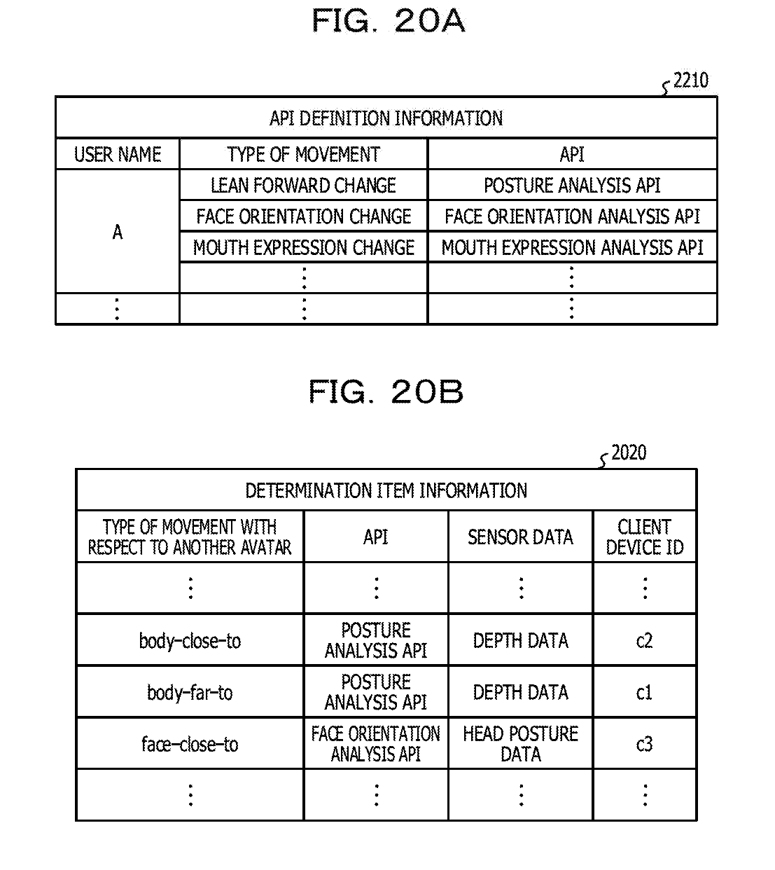

Next, definition information which is stored in the definition information storing unit 115 and used when the movement (social behavior) determination unit 1703 determines the type of movement with respect to another avatar will be described. FIGS. 20A and 20B are diagrams illustrating definition information used for determining the type of movement with respect to another avatar, among the definition information stored in the definition information storing unit.

As illustrated in FIGS. 20A and 20B, the definition information for determining the type of movement with respect to another avatar includes API definition information 2010 and determination item information 2020.

As illustrated in FIG. 20A, API used to determine the type of movement with respect to another avatar is defined in API definition information 2010 for each “user name” and each “type of movement”. When the type of movement of a user is determined by the movement (change of motion) determination unit 1702, the movement (social behavior) determination unit 1703 executes corresponding API. In the example of FIG. 20A, in a case where the type of movement of a user having a user name of “A” is determined as “lean forward change” by the movement (change of motion) determination unit 1702, the movement (social behavior) determination unit 1703 determines the type of movement with respect to another avatar by executing posture analysis API. Moreover, in a case where the types of movements of the user having a user name of “A” are determined as “face orientation change” and “mouth expression change” by the movement (change of motion) determination unit 1702, the movement (social behavior) determination unit 1703 executes face orientation analysis API and mouth expression analysis API respectively. In this manner, the movement (social behavior) determination unit 1703 determines the type of movement with respect to another avatar.

As illustrated in FIG. 20B, the “sensor data” used for each determination described above and the “client device ID” of a transmission source of each piece of sensor data are defined in the determination item information 2020. Further, the “type of movement with respect to another avatar” determined by inputting sensor data and “API” used for determination are defined in the determination item information 2020.

For example, the movement (social behavior) determination unit 1703 inputs depth data transmitted from the client device 130 having a client device ID of “c2” to the posture analysis API. In this manner, the movement (social behavior) determination unit 1703 determines whether the movement of an avatar is a movement of approaching another avatar (“body-close-to”). Further, the movement (social behavior) determination unit 1703 inputs depth data transmitted from the client device 120 having a client device ID of “c1” to the posture analysis API. In this manner, the movement (social behavior) determination unit 1703 determines whether the movement of an avatar is a movement of moving away from another avatar (“body-far-to”).

Further, the movement (social behavior) determination unit 1703 inputs head posture data transmitted from the client device 140 having a client device ID of “c3” to the face orientation analysis API. In this manner, the movement (social behavior) determination unit 1703 determines whether the movement of an avatar is a movement of turning the face to another avatar (“face-close-to”).

Moreover, in the example of FIG. 20B, the case where one type of sensor data is used to determine one type of movement with respect to another avatar has been described. However, plural types of sensor data may be used to determine one type of movement with respect to another avatar.

Outline of Log Recording Processing that Determines Type of Movement and Type of Movement With Respect to Another Avatar and Records Results

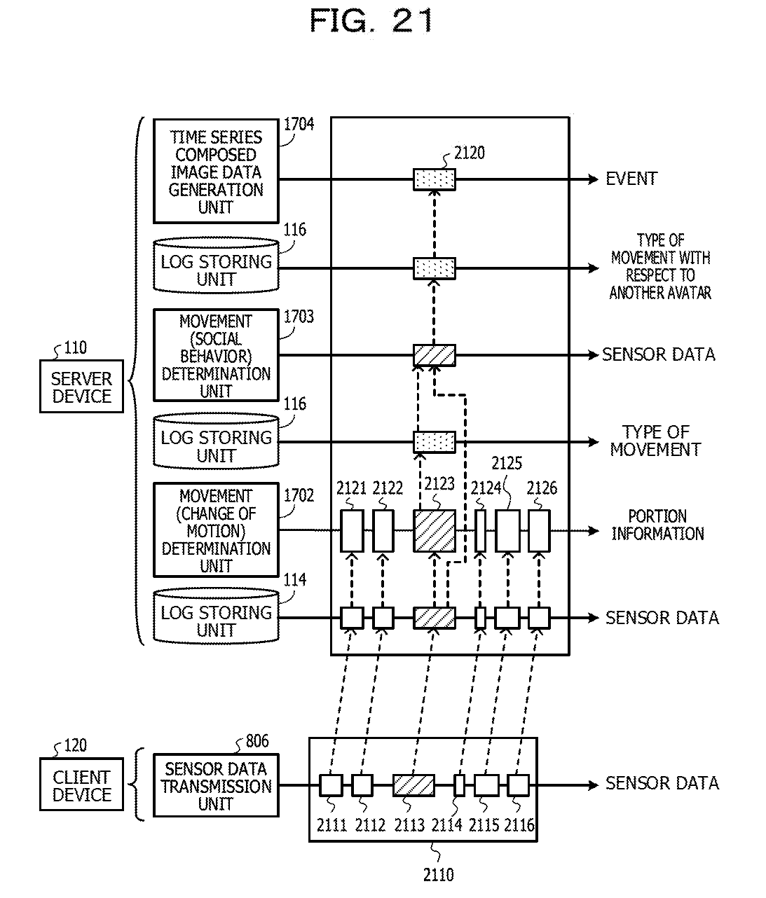

Next, the outline of a process (log recording processing of determining and recording the type of movement and the type of movement with respect to another avatar) from a behavior of a user to occurrence of an action event, among processes of the information providing unit 112 for time series composed image data of the server device 110, will be described. FIG. 21 is a diagram for describing a flow of the process from a behavior of a user to occurrence of an action event.

In FIG. 21, a sensor data group 2110 indicates a predetermined amount of sensor data group acquired in the client device 120. Sensor data 2111 to 2116 included in the sensor data group 2110 are respectively transmitted to the server device 110 by the sensor data transmission unit 806.

As illustrated in FIG. 21, the predetermined amount of sensor data 2111 to 2116 transmitted to the server device 110 are sequentially stored in the sensor data storing unit 114. The predetermined amount of sensor data 2111 to 2116 stored in the sensor data storing unit 114 are read out by the information generation unit 1202 for a VR space, and portion information 2121 to 2126 of each portion of an avatar are calculated by the information generation unit 1202 for a VR space. Moreover, for the sake of simplicity of the description, the portion information 2121 to 2126 are used as portion information of portions of a predetermined target avatar to be monitored.

The movement (change of motion) determination unit 1702 acquires the portion information 2121 to 2126 calculated by the information generation unit 1202 for a VR space and determines whether any of the portion information 2121 to 2126 is changed more than a predetermined amount. Further, in a case where the movement (change of motion) determination unit 1702 determines that any of the portion information is changed more than a predetermined amount, the movement (change of motion) determination unit 1702 determines the type of movement related to the portion information.

For example, the movement (change of motion) determination unit 1702 determines whether the portion value of the portion information 2121 is changed more than a predetermined amount by comparing the portion information 2121 with definition information (for example, FIG. 19B). Similarly, the movement (change of motion) determination unit 1702 determines whether any portion value of the portion information 2122 to 2126 is changed more than a predetermined amount by comparing definition information (for example, FIG. 19B) with each of the portion information 2122 to 2126.

Here, it is assumed that the movement (change of motion) determination unit 1702 determines that the portion value of the portion information 2123 is changed more than a predetermined amount. In this case, the movement (change of motion) determination unit 1702 determines the type of movement related to the portion information 2123 based on the definition information (for example, FIG. 19B) and stores the determination results by adding a new data row to the “movement type determination log table” of the log storing unit 116.

When a new data row is added to the “movement type determination log table” by the movement (change of motion) determination unit 1702, the movement (social behavior) determination unit 1703 determines the type of movement with respect to another avatar based on the sensor data 2113. Specifically, the movement (social behavior) determination unit 1703 determines the type of movement with respect to another avatar by inputting the sensor data 2113 to API in accordance with the type of movement.

The movement (social behavior) determination unit 1703 stores the determined type of movement with respect to another avatar and the time ranges (determination time (start) and determination time (finish)) of sensor data used for the determination in the “type determination log table with respect to another avatar” of the log storing unit 116. When the determination result determined by the movement (social behavior) determination unit 1703 is added to the “movement type determination log table with respect to another avatar” of the log storing unit 116 as a new data row, the time series composed image data generation unit 1704 determines that an action event 2120 occurs.

When the time series composed image data generation unit 1704 determines that the action event 2120 occurs, occurrence of a reaction event is monitored (the flow after the occurrence of the action event 2120 will be described later).

Flow of Log Recording Processing Determining and Recording Type of Movement and Type of Movement with Respect to Another Avatar

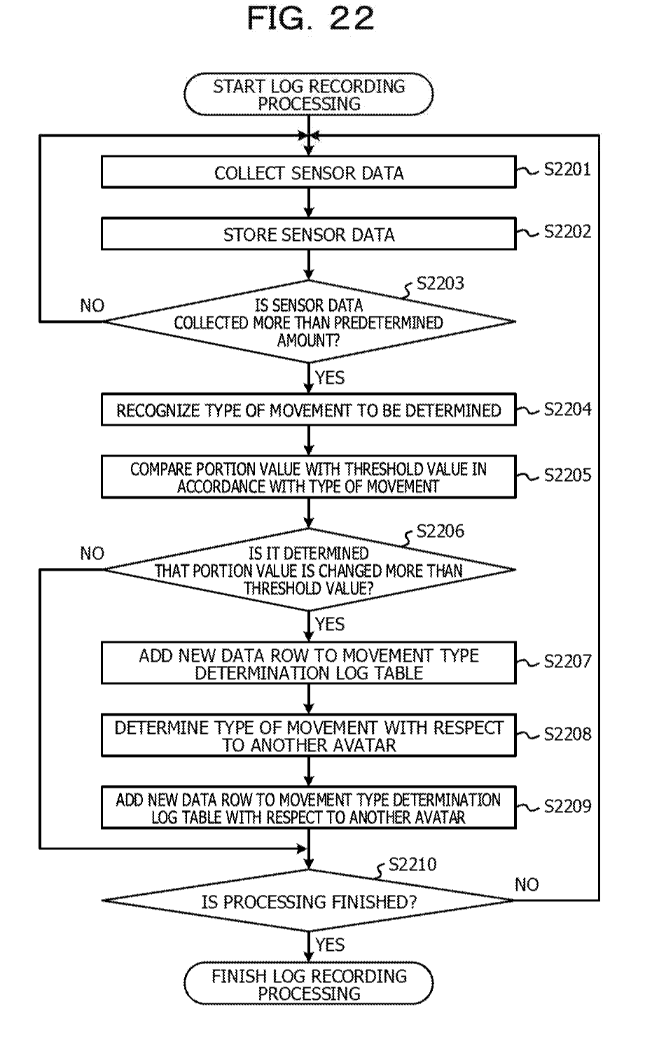

Next, the flow of a process (log recording processing of determining and recording the type of movement and the type of movement with respect to another avatar) from a behavior of a user to occurrence of an action event, among processes of the information providing unit 112 for time series composed image data of the server device 110, will be described. FIG. 22 is a flowchart of log recording processing executed by the server device.

In Step S2201, the sensor data collection unit 1201 collects sensor data obtained by sensing behaviors of the users 150 to 170 in the real space from the client devices 120 to 140.

In Step S2202, the sensor data collection unit 1201 stores collected sensor data in the sensor data storing unit 114.

In Step S2203, the processing condition determination unit 1701 determines whether the amount of sensor data newly stored in the sensor data storing unit 114 is greater than or equal to a predetermined amount.

In Step S2203, in a case where it is determined that the amount of newly stored sensor data is less than the predetermined amount, the process returns to Step S2201 and collection and storage of sensor data are continued.

In Step S2203, in a case where it is determined that the amount of newly stored sensor data is greater than or equal to the predetermined amount, the process proceeds to Step S2204. In Step S2204, the movement (change of motion) determination unit 1702 recognizes the type of movement to be determined and portions and threshold values of a target to be monitored when the type of each movement is determined, based on the definition information (FIGS. 19A and 19B).

In Step S2205, the movement (change of motion) determination unit 1702 acquires portion information in which the portion values are respectively calculated by the information generation unit 1202 for a VR space based on the newly stored sensor data. Further, the movement (change of motion) determination unit 1702 compares a threshold value recognized in Step S2204 with a portion value of portion information related to portions of a target to be monitored, among the acquired portion information.

In Step S2206, the movement (change of motion) determination unit 1702 determines whether the portion information related to portions of a target to be monitored is changed more than the threshold value based on the comparison result. In Step S2206, in a case where it is determined that the portion information of portions of a target to be monitored is not changed more than the threshold value, the process proceeds to Step S2210.

Meanwhile, in Step S2206, in a case where it is determined that the portion information of portions of a target to be monitored is changed more than the threshold value, the process proceeds to Step S2207. In Step S2207, the movement (change of motion) determination unit 1702 determines the type of movement of the portion information which is changed more than the threshold value. Moreover, the movement (change of motion) determination unit 1702 stores the determination result by adding a new data row to the “movement type determination log table” of the log storing unit 116.

When a new data row is added to the “movement type determination log table” of the log storing unit 116 and the type of movement and the like are stored, in Step S2208, the movement (social behavior) determination unit 1703 calls API in accordance with the type of movement determined by the movement (change of motion) determination unit 1702. Further, the movement (social behavior) determination unit 1703 determines the type of movement with respect to another avatar by inputting sensor data to the called API.

In Step S2209, the movement (social behavior) determination unit 1703 stores the determination result determined in Step S2208 by newly adding a data row to the “movement type determination log table with respect to another avatar” of the log storing unit 116. Further, the determination result stored in the data row newly added thereto includes the type of movement with respect to another avatar and time ranges (determination time (start) and determination time (finish)) of sensor data used for the determination.

In Step S2210, the processing condition determination unit 1701 determines whether to finish the time series composed image data generation processing. In a case where it is determined not to finish the time series composed image data generation processing, the process returns to Step S2201 and the log recording processing is continued.

Meanwhile, in Step S2210, in a case where it is determined to finish the time series composed image data generation processing, the log recording processing is finished.

Description of Log Table to be Recorded by Log Recording Processing

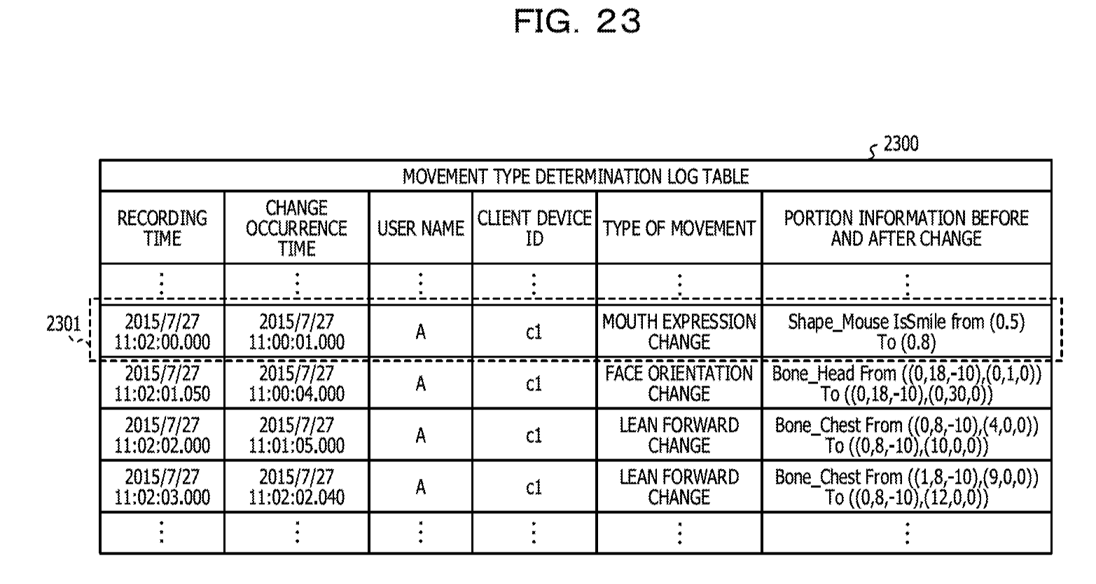

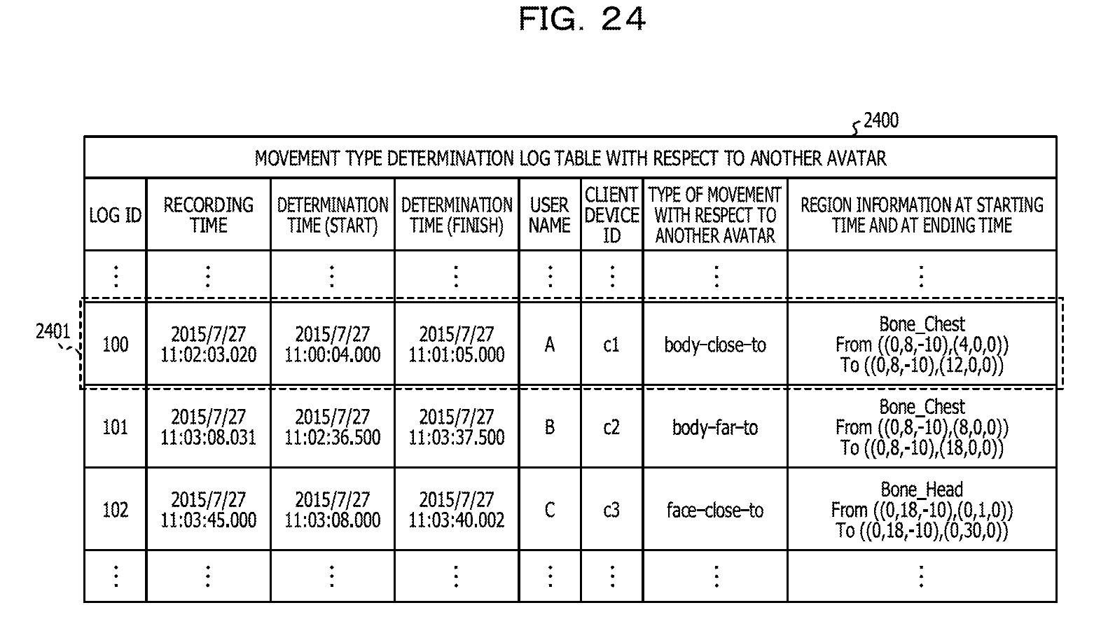

Next, the “movement type determination log table” and the “movement type determination log table with respect to another avatar” recorded in the log storing unit 116 by executing the log recording processing illustrated in FIG. 22 will be described with reference to FIGS. 23 and 24.

(1) Description of Movement Type Determination Log Table

FIG. 23 is a diagram illustrating an example of a movement type determination log table. As illustrated in FIG. 23, the movement type determination log table 2300 includes, as items of information, “recording time”, “change occurrence time”, “user name”, “client device ID”, “movement type” and “portion information before and after change”.

The time of a new data row being added to the movement type determination log table 2300 of the log storing unit 116 and the movement type and the like being stored therein is recorded in the “recording time”. The time of sensor data, used when the movement type is determined by changing portion information more than a predetermined amount, being acquired by the sensor data acquisition unit 802 is recorded.

The user names of users corresponding to avatars utilizing a head posture sensor are recorded in the “user name”. Identifiers for identifying the client devices that transmit sensor data used for determination of the type of movement are recorded in the “client device ID”.

The type of movement of an avatar determined based on the portion information is recorded in the “type of movement”. Portion information before more than a predetermined amount of change occurs and portion information after more than a predetermined amount of change occurs are recorded in the “portion information before and after change”.

An example of the data row 2301 of FIG. 23 represents that a new data row is added to the movement type determination log table 2300 of the log storing unit 116 at “11:02:00:000 on Jul, 27, 2015” and the type of movement is stored. Further, the example of the data row 2301 represents that the portion information of the avatar 250 of the user 150 having a user name of “user A” is changed more than a predetermined amount and the type of movement is determined as the “mouth expression change”. Further, the example of the data row 2301 represents that the sensor data used for determination of the type of movement is acquired by the client device 120 having a client device ID of “c1” at 11:00:01:000 on Jul. 27, 2015. Furthermore, the example of the data row 2301 represents that the parameter (“IsSmile”) of portion information (“Shape_Mouth”) calculated based on the sensor data is changed from “0.5” to “0.8”

(2) Description of Movement Type Determination Log Table with Respect to Another Avatar

FIG. 24 is a diagram illustrating an example of a movement type determination log table with respect to another avatar. As illustrated in FIG. 24, a movement type determination log table 2400 with respect to another avatar includes, as items of information, “log ID”, “recording time”, “determination time (start)”, and “determination time (finish)”. Further, the movement type determination log table 2400 with respect to another avatar includes, as items of information, “user name”, “client device ID”, “movement type with respect to another avatar”, and “portion information at the time of start and finish”.

Identifiers provided whenever a new data row is added to the movement type determination log table 2400 with respect to another avatar of the log storing unit 116 and the type of movement with respect to another avatar is stored are recorded in the “log ID”.

The time at which a new data row is added to the movement type determination log table 2400 with respect to another avatar of the log storing unit 116 and the type of movement with respect to another avatar is stored is recorded in the “recording time”. The time ranges of sensor data used to determinate the type of movement with respect to another avatar are recorded in the “determination time (start) and determination time (finish)”.

The user name of a user corresponding to an avatar in which the type of movement with respect to another avatar is determined is recorded in the “user name”. Identifiers for identifying client devices that transmit the sensor data used to determine the type of movement with respect to another avatar are recorded in the “client device ID”.

The type of movement with respect to another avatar which is determined based on the sensor data is recorded in the “type of movement with respect to another avatar”. Portion information at the “determination time (start)” and portion information at the “determination time (finish)” are recorded in the “portion information at the time of start and finish”.

An example of the data row 2401 of FIG. 24 represents that a new data row is added to the movement type determination log table 2400 with respect to another avatar of the log storing unit 116 at “11:02:03:020 on Jul. 27, 2015” and the type of movement is stored. Further, it is represented that a log ID of “100” is provided for the data row 2401 of FIG. 24 when a data row is added. Further, the example of the data row 2401 represents that the type of movement of the avatar 250 of the user 150 having a user name of “user A” with respect to another avatar is determined and sensor data used for the determination is transmitted from the client device having a client device ID of “c1”.

In addition, the example of the data row 2401 represents that the time range of the sensor data used for the determination is from “11:00:04:000 on Jul. 27, 2015” to “11:01:05:000 on Jul. 27, 2015”. Further, the example of the data row 2401 represents that a portion in which a change has occurred as a trigger of determination is the “Bone_Chest”. Further, the example of the data row 2401 represents that the position and the rotation angle which are the portion information of the portion are changed from (0, 8, -10) and (4, 0, 0) to (0, 8 -10) and (12, 0, 0) during the above-described time range. In addition, the example of the data row 2401 represents that the type of movement with respect to another avatar is determined as “body-close-to”.

Outline of Time Series Composed Image Data Providing Processing Executed by Information Providing Unit for Time Series Composed Image Data

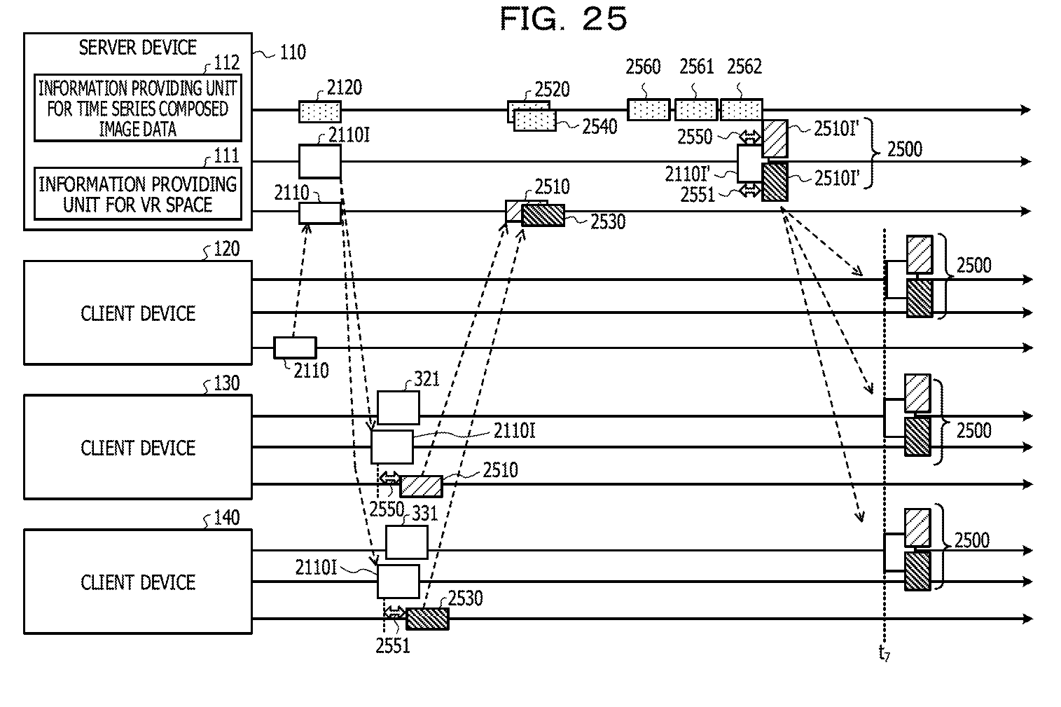

Next, a flow (outline of time series composed image data providing processing executed by the information providing unit for time series composed image data) from a behavior of a user to displaying of time series composed image data will be described using FIG. 25 with reference to FIGS. 3 to 5. Further, the time series composed image data providing processing also includes the above-described log recording processing, but the description of the log recording processing will be simplified here. FIG. 25 is a diagram for describing the flow from a behavior of a user to displaying of time series composed image data

In FIG. 25, among three solid lines extending from the server device 110, the first solid line is a line for indicating the timing for the information providing unit 112 for time series composed image data to process an event or the like. The second line is a line for indicating the timing for the information providing unit 111 for a VR space to generate time series image data of a VR space. Further, the third line is a line for indicating the timing for the information providing unit 111 for a VR space to process the sensor data.

In FIG. 25, among three solid lines respectively extending from the client devices 120 to 140, the first solid line is a line for indicating the timing for the client device to display a visual field image group or time series composed image data. The second solid line is a line for indicating the timing for the client device to receive information for a VR space. Further, the third solid line is a line for indicating the timing for the client device to acquire the sensor data.

Moreover, in FIG. 25, rectangular figures allocated on solid lines for indicating each timing include longitudinally long figures and longitudinally short figures. The longitudinally long figures indicate data related to time series image data and the longitudinally short figures indicate data unrelated to time series image data.

When the client device 120 acquires a sensor data group 2110 (a predetermined amount of sensor data) because of a behavior of the user 150 (for example, an arrow 301 of FIG. 3), the client device 120 transmits the sensor data group 2110 to the server device 110.

The information providing unit 111 for a VR space of the server device 110 calculates portion information of the avatar 250 of the user 150 based on the sensor data group 2110 collected by the client device 120. In addition, the information providing unit 111 for a VR space generates time series image data 21101 of a VR space based on the portion information of the avatar 250 of the user 150 and transmits the image group to the client devices 130 and 140 respectively. Moreover, the information providing unit 112 for time series composed image data of the server device 110 determines whether the portion information calculated by the information providing unit 111 for a VR space is changed more than a predetermined amount and then determines the type of movement in a case where it is determined that the portion information is changed more than a predetermined amount. Further, the information providing unit 112 for time series composed image data reads out API in accordance with the determined type of movement and determines the type of movement with respect to another avatar based on the sensor data group 2110. Further, the information providing unit 112 for time series composed image data of the server device 110 stores the determination result by adding a new data row to the movement type determination log table 2400 with respect to another avatar. In this manner, the information providing unit 112 for time series composed image data of the server device 110 determines that the action event 2120 occurs.

The client devices 130 and 140 to which the image group 2110I of a VR space is transmitted generate visual field images 321 and 331 (see FIG. 3) at each time frame and controls the generated visual field images to be respectively display on the HMD 133 and 143.

It is assumed that the user 160 performs a behavior (for example, the arrow 302 of FIG. 4) due to the visual field image 321 at each time frame being displayed and the client device 130 acquires a sensor data group 2510. The client device 130 transmits the acquired sensor data group 2510 to the server device 110.

It is assumed that the user 170 performs a behavior (for example, the arrow 303 of FIG. 4) due to the visual field image 331 at each time frame being displayed and the client device 140 acquires a sensor data group 2530. The client device 140 transmits the acquired sensor data group 2530 to the server device 110.

The information providing unit 111 for a VR space of the server device 110 calculates portion information of each of the avatars 260 and 270 based on the sensor data group 2510 and the sensor data group 2530. Further, the information providing unit 112 for time series composed image data of the server device 110 determines whether the portion information calculated by the information providing unit 111 for a VR space is changed more than a predetermined amount and determines the type of movement in a case where it is determined that the portion information is changed more than a predetermined amount. Further, the information providing unit 112 for time series composed image data reads out API in accordance with the determined type of movement and determines the type of movement with respect to another avatar based on each of the sensor data groups 2510 and 2530. Further, the information providing unit 112 for time series composed image data of the server device 110 stores the determination result by adding a new data row to the movement type determination log table 2400 with respect to another avatar. In this manner, the information providing unit 112 for time series composed image data of the server device 110 determines that reaction events 2520 and 2540 occur.

When the action event 2120 occurs, the information providing unit 112 for time series composed image data transmits the action event 2120 to the client devices 130 and 140 and receives a notification of completion of receiving the action event from the client devices 130 and 140. Similarly, the information providing unit 112 for time series composed image data transmits the reaction event 2520 or 2540 to the client device 120 and receives a notification of completion of receiving the reaction event from the client device 120.

The information providing unit 112 for time series composed image data calculates an actual communication speed based on the time from when the action event 2120 is transmitted to when the notification of completion of receiving the action event is received. Further, the information providing unit 112 for time series composed image data calculates an actual communication speed based on the time from when the reaction event 2520 or 2540 is transmitted to when the notification of completion of receiving the reaction event is received. The information providing unit 112 for time series composed image data predicts the time for time series composed image data 2500 to arrive at the client devices 120 to 140 based on the calculated actual communication speed. In this manner, the information providing unit 112 for time series composed image data determines the displaying start timing (for example, the time t7 of FIGS. 5 and 25) of the time series composed image data 2500.

Moreover, the client device 130 in which the action event 2120 is received allows display timing information, representing the timing (output timing) at which the visual field image 321 at each time frame is displayed on the HMD 133 of the user 160, to be included in the notification of completion of receiving the action event and transmits the display timing information. In addition, the client device 140 in which the action event 2120 is received allows display timing information, representing the timing (output timing) at which the visual field image 331 at each time frame is displayed on the HMD 143 of the user 170, to be included in the notification of completion of receiving the action event and transmits the display timing information.

In this manner, the information providing unit 112 for time series composed image data is capable of extracting display timing information based on the notification of completion of receiving an action event respectively received by the client devices 130 and 140.

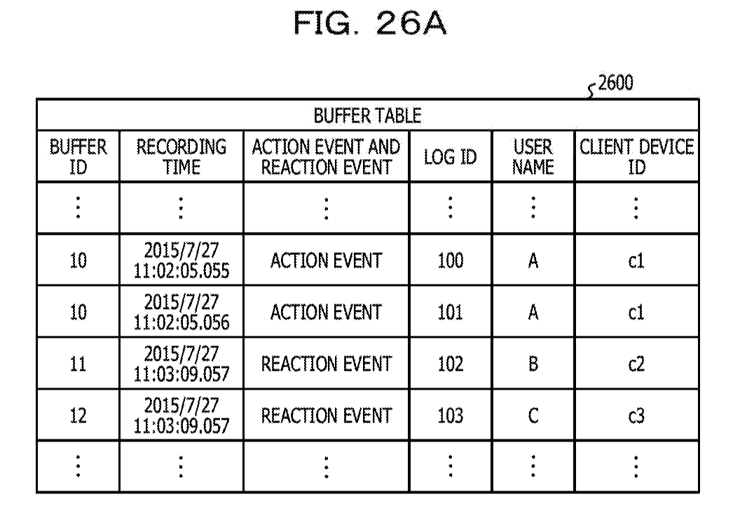

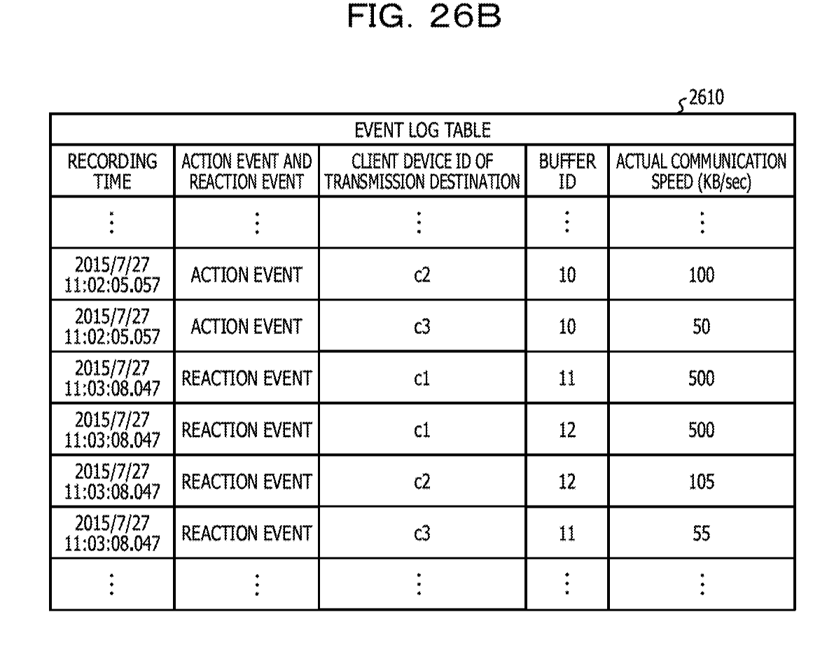

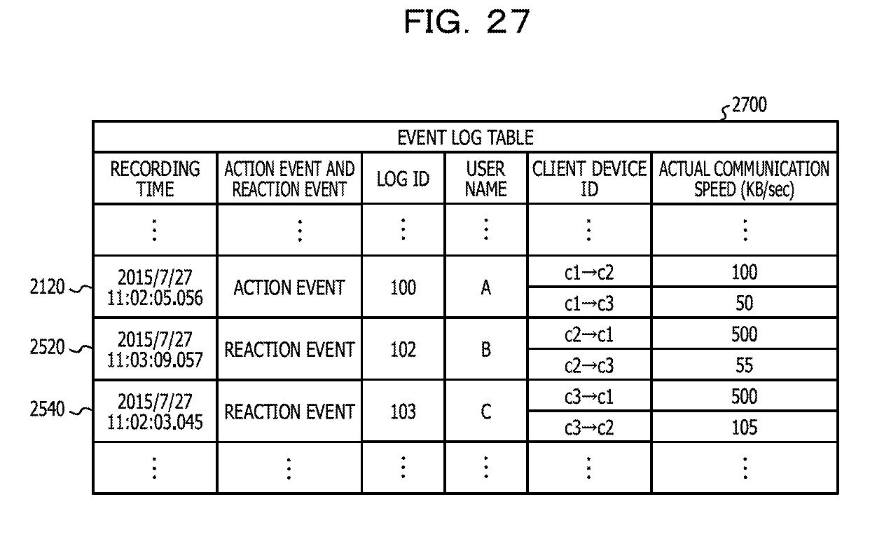

The information providing unit 112 for time series composed image data stores information, acquired from when the action event 2120 occurs to when the notification of completion of receiving the action event is received, in a “buffer table” and an “event table” (the details will be described layer with reference to FIGS. 26A and 26B). Further, the information providing unit 112 for time series composed image data stores information 2560, derived based on the information stored in the “buffer table” and the “event table”, in an “action event and reaction event log reference table” (the details will be described layer with reference to FIG. 27).

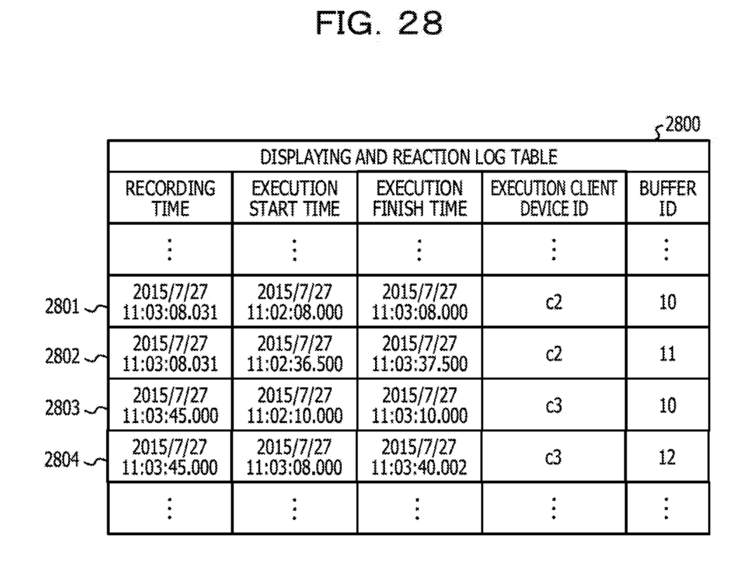

Moreover, the information providing unit 112 for time series composed image data stores information, acquired from when the image group 2110I is transmitted to the client devices 130 and 140 to when the sensor data groups 2510 and 2530 are received, in a “displaying and reaction log table” (the details will be described below with reference to FIG. 28). Further, the information providing unit 112 for time series composed image data derives time series composed image data generation information 2561 and time series composed image data displaying instruction information 2562. The time series composed image data generation information 2561 and the time series composed image data displaying instruction information 2562 are information indispensable for generation and displaying of the time series composed image data 2500.

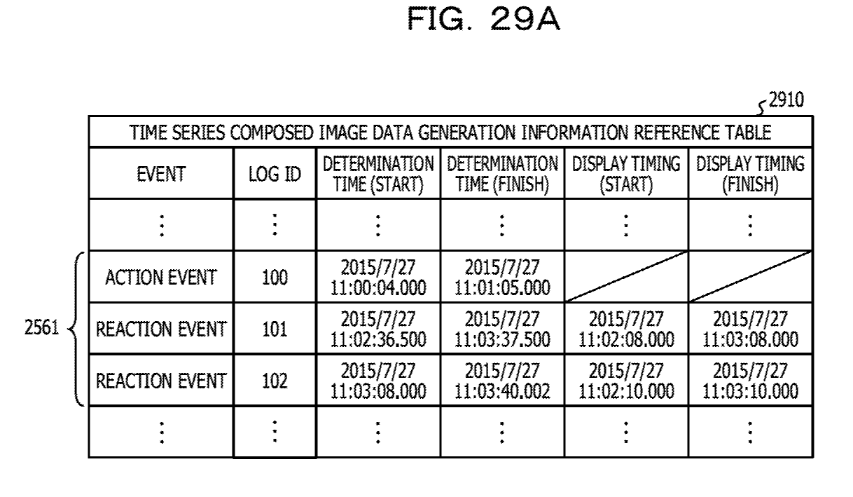

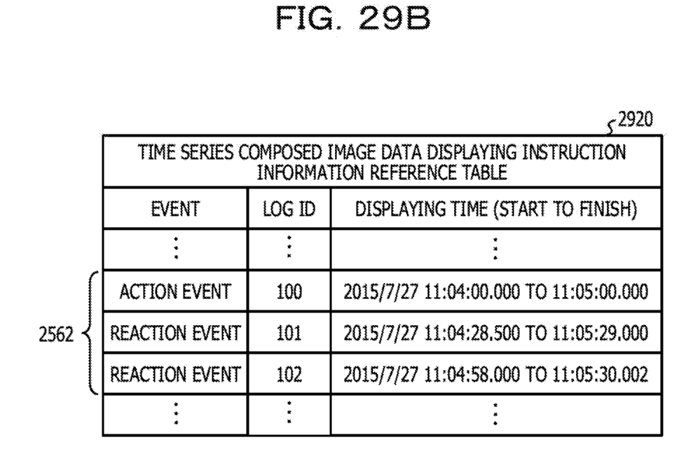

In addition, the information providing unit 112 for time series composed image data respectively stores the time series composed image data generation information 2561 and the time series composed image data displaying instruction information 2562 in a “time series composed image data generation information reference table” and a “time series composed image data displaying instruction information reference table” (the details will be described later with reference to FIGS. 29A and 29B).

Moreover, the information providing unit 112 for time series composed image data generates the time series composed image data 2500 based on the time series composed image data generation information 2561 and transmits the time series composed image data 2500 to the client devices 120 to 140 based on the time series composed image data displaying instruction information 2562.

Description 1 of Information Recorded After Occurrence of Action Event in Time Series Composed Image Data Providing Processing

The “buffer table” and the “event log table” in which information acquired from when the action event 2120 has occurred to when a notification of completion of receiving the action event is received is stored and reference tables derived from both of the tables will be described.

(1) Description of Buffer Table

FIG. 26A is a diagram illustrating an example of a buffer table. A new data row is added to the movement type determination log table 2400 with respect to another avatar and a new data row is added to the buffer table 2600 whenever it is determined that an event has occurred.

When an action event has occurred so that a new data row is added to the buffer table 2600, the buffer table 2600 waits for a new data row to be added by an event having occurred based on the sensor data from another client device for a certain period of time.

In the buffer table 2600, when a new data row is added by an event having occurred based on the sensor data from another client device, the waiting is completed. In a case where a data row is added within a certain period of time after a data row is added to the buffer table 2600 along with the occurrence of an action event, an event corresponding to the data row is determined as a reaction event corresponding to the action event.

(2) Description of Event Log Table

FIG. 26B illustrates an example of an event log table. Since the information providing unit 112 for time series composed image data transmits an event having occurred to another client device, transmission and reception of an event are recorded in the event log table 2610. Further, at the time of transmission and reception of an event, the information providing unit 112 for time series composed image data measures the communication speed and records the measurement result in the event log table 2610.

(3) Action Event and Reaction Event Log Reference Table

Next, the “action event and reaction event log reference table” that stores information derived based on the information stored in the buffer table 2600 and the event log table 2610 will be described with reference to FIG. 27. The action event and reaction event log reference table is a table in which information derived based on the information stored in the buffer table 2600 and the event log table 2610 is summarized in an easy-to-understand manner.

FIG. 27 is a diagram illustrating an example of an action event and reaction event log reference table. As illustrated in FIG. 27, an action event and reaction event log reference table 2700 includes, as items of information, “recording time” and “action event and reaction event”. Further, the action event and reaction event log reference table 2700 includes, as items of information, “log ID”, “user name”, “client device ID”, and “actual communication speed”.

The time at which it is determined that an action event or a reaction event has occurred and the action event or a reaction event is stored in the log storing unit 116 is recorded in the “recording time”.

Information related to discrimination of whether an event having occurred is an action event or a reaction event is recorded in the “action event and reaction event”. A log ID stored in the data row corresponding to the action event 2120 among respective data rows stored in the movement type determination log table 2400 with respect to another avatar is recorded in the “log ID”.

A user name of a user which is a source of an avatar that causes an action event or a reaction event is stored in the “user name”. An identifier for identifying a client device used by the user which is a source of an avatar that causes an action event or a reaction event is stored in the “client device ID”. Further, an identifier for identifying a client device which is a transmission source of an action event or a reaction event is stored in the “client device ID”.

An actual communication speed calculated based on the time taken until a notification of completion of receiving an action event or a notification of completion of receiving a reaction event is received when an action event or a reaction event has occurred is stored in the “actual communication speed”.

Description 2 of Information Recorded After Occurrence of Reaction Event in Time Series Composed Image Data Providing Processing

Next, the “displaying and reaction log table” in which displaying of a movement of an avatar which corresponds to an action event in another client device and a behavior (reaction) of another user along with the displaying are recorded will be described. Further, reference tables (time series composed image data generation information reference table and time series composed image data displaying instruction information reference table) derived based on the displaying and reaction log table will be described.

(1) Displaying and Reaction Log Table

The information providing unit 112 for time series composed image data records the timing at which a movement of an avatar which corresponds to an action event is displayed and the timing at which another user has responded along with the displaying in a client device are recorded in the “displaying and reaction log table”.

FIG. 28 is a diagram illustrating an example of a displaying and reaction log table. As illustrated in FIG. 28, the timing at which a movement of an avatar which corresponds to an action event is displayed is recorded, as an “execution start time” and an “execution finish time”, in a displaying and reaction log table 2800.

In the displaying and reaction log table 2800, a data row 2801 represents that a movement of an avatar which corresponds to an action event is displayed in the client device 130 having a client ID of “c2”. Further, a data row 2803 represents that a movement of an avatar which corresponds to an action event is displayed in the client device 140 having a client ID of “c3”.

In addition, the timing at which another user has responded along with the displaying is recorded, as the “execution start time” and the “execution finish time”, in the displaying and reaction log table 2800.

In the displaying and reaction log table 2800, a data row 2802 represents that the user 160 using the client device 130 has responded in the client device 130 having a client ID of “c2”. Further, a data row 2804 represents that the user 170 using the client device 140 has responded in the client device 140 having a client ID of “c3”.

(2) Time Series Composed Image Data Generation Information Reference Table and Time Series Composed Image Data Displaying Instruction Information Reference Table

Next, the “time series composed image data generation information reference table” and the “time series composed image data displaying instruction information reference table” will be described with reference to FIGS. 29A and 29B. The “time series composed image data generation information reference table” is a table in which information indispensable for generation of the time series composed image data 2500 derived based on information stored in the displaying and reaction log table 2800 is summarized. In addition, the “time series composed image data displaying instruction information reference table” is a table in which information indispensable for displaying of the time series composed image data 2500 derived based on information stored in the event log table 2610 and the displaying and reaction log table 2800 is summarized. Hereinafter, the time series composed image data generation information reference table and the time series composed image data displaying instruction information reference table will be described.

FIG. 29A is a diagram illustrating an example of time series composed image data generation information reference table. As illustrated in FIG. 29A, the time series composed image data generation information 2561 indispensable for generation of the time series composed image data 2500 is stored in time series composed image data generation information reference table 2910. At the time of generation of the time series composed image data 2500, the information providing unit 112 for time series composed image data specifies an action event and a reaction event which are targets for generation of time series composed image data. Accordingly, an “event” is stored in the time series composed image data generation information reference table 2910 as information for specifying an action event and a reaction event which are targets for generation of time series composed image data. An action event and a reaction event occur when a new data row is stored in the movement type determination log table 2400 with respect to another avatar and a log ID is provided. Therefore, a “log ID” is stored in the time series composed image data generation information reference table 2910 as information for specifying the action event 2120 and the reaction event 2520 and 2540.

Further, at the time of generation of the time series composed image data 2500, the information providing unit 112 for time series composed image data determines the range of sensor data to be extracted for generating time series image data in which a behavior of each user is reflected to the movement of an avatar. For this reason, the “determination time (start)” and the “determination time (finish)” in which the action event 2120 is read by the movement type determination log table 2400 with respect to another avatar are stored in the time series composed image data generation information reference table 2910. The “determination time (start)” and the “determination time (finish)” in which the reaction events 2520 and 2540 are read by the movement type determination log table 2400 with respect to another avatar are stored in the time series composed image data generation information reference table 2910.

Further, at the time of generation of the time series composed image data 2500, the information providing unit 112 for time series composed image data acquires display timing information in which the movement of the avatar 250 that causes an action event is displayed on the HMD 133 of the user 160 or the HMD 143 of the user 170. For this reason, the “display timing (start)” and the “display timing (finish)” are stored in the time series composed image data generation information table 2710.

FIG. 29B is a diagram illustrating an example of time series composed image data displaying instruction information reference table. As illustrated in FIG. 29B, information indispensable for displaying of the time series composed image data 2500 is stored in the time series composed image data displaying instruction information reference table 2920.

At the time of displaying of the time series composed image data 2500, the information providing unit 112 for time series composed image data calculates the displaying time of time series image data 2110I′, time series image data 2510I′, and time series image data 2530I′ included in the time series composed image data 2500. Therefore, the displaying time (start to finish) of the image group 2110I′, the image group 2510I′, and the image group 2530I′ included in the time series composed image data 2500 are stored in the time series composed image data displaying instruction information reference table 2920 in association with the “event” and the “log ID”.

Outline of Procedures for Generating Time Series Composed Image Data in Time Series Composed Cmage Data Providing Processing

Next, the procedures of generating the time series composed image data 2500 by the information providing unit 112 for time series composed image data will be described.

As described above, the “determination time (start)” and the “determination time (finish)” corresponding to the action event 2120 are stored in the time series composed image data generation information reference table 2910. The information providing unit 112 for time series composed image data extracts sensor data, among the sensor data group 2110, in a time range specified based on the “determination time (start)” and the “determination time (finish)” and generates the image group 2110I′.

Similarly, the “determination time (start)” and the “determination time (finish)” corresponding to the reaction event 2520 are stored in the time series composed image data generation information reference table 2910. The information providing unit 112 for time series composed image data extracts sensor data, among the sensor data group 2530, in a time range specified based on the “determination time (start)” and the “determination time (finish)” and generates the image group 2510I′.

Similarly, the “determination time (start)” and the “determination time (finish)” corresponding to the reaction event 2540 are stored in the time series composed image data generation information reference table 2910. The information providing unit 112 for time series composed image data extracts sensor data, among the sensor data group 2530, in a time range specified based on the “determination time (start)” and the “determination time (finish)” and generates the image group 2530I′.

The “display timing (start)” is stored in the time series composed image data generation information reference table 2910 as display timing information in which the movement of the avatar 250 corresponding to the action event 2120 is displayed. The time stored in association with the reaction event 2520 among the time stored in the “display timing (start)” is a time of the avatar 260 of the user 160 starting a movement in response to the movement of the avatar 250 of the user 150. That is, this time corresponds to information (reaction timing information of the user 160) related to the reaction timing of a social behavior (reaction) of the user 160 performed with respect to the user 150 in the real space.

Here, the information providing unit 112 for time series composed image data calculates a deviation (arrow 2550) between both times based on a difference between reaction timing information of the user 160 and display timing information in which the visual field image 321 at each time is displayed on the HMD 133 of the user 160. In addition, the information providing unit 112 for time series composed image data synthesizes the image group 2110I′ and the image group 2510I′ with a time difference according to the calculated deviation.

Similarly, the time stored in association with the reaction event 2540 among the time stored in the “display timing (start)” is a time of the avatar 270 of the user 170 starting a movement in response to the movement of the avatar 250 of the user 150. That is, this time corresponds to information (reaction timing information of the user 170) related to the reaction timing of a social behavior (reaction) of the user 170 performed with respect to the user 150 in the real space.

Here, the information providing unit 112 for time series composed image data calculates a deviation (arrow 2551) between both times based on a difference between reaction timing information of the user 170 and display timing information in which the visual field image 331 at each time is displayed on the HMD 143 of the user 170. In addition, the information providing unit 112 for time series composed image data synthesizes the image group 21101′ and the image group 2530I′ with a time difference according to the calculated deviation.

Outline of Procedures for Reproducing Time Series Composed Image Data in Time Series Composed Image Data Providing Processing

Next, the procedures of reproducing the time series composed image data 2500 performed by the information providing unit 112 for time series composed image data will be described.

As described above, the times of reproducing the image group 2110I′, the image group 2510I′, and the image group 2530I′ included in the time series composed image data 2500 are stored in the time series composed image data displaying instruction information reference table 2920. The information providing unit 112 for time series composed image data transmits information for time series composed image data which includes the generated time series composed image data 2500 and the times of reproducing the image group 2110I′, the image group 2510I′, and the image group 2530I′ included in the time series composed image data 2500, to the client devices 120 to 140. In this manner, the client devices 120 to 140 are capable of reproducing the time series composed image data by being synchronized with the time series composed image data 2500 at the same time (for example, the time t7 of FIG. 5 or FIG. 25).

Flow of Information Providing Processing for Time Series Composed Image Data Which is Executed by Information Providing Unit for Time Series Composed Image Data

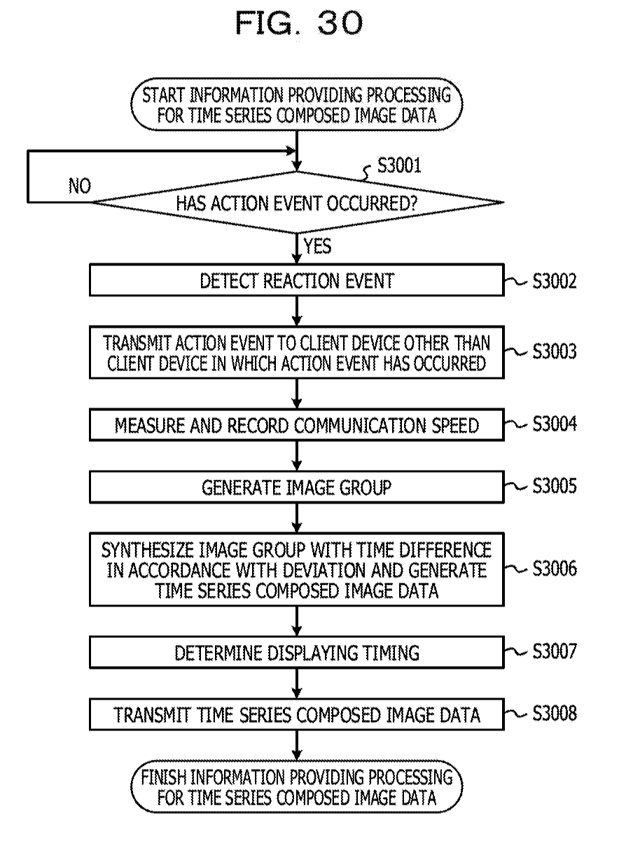

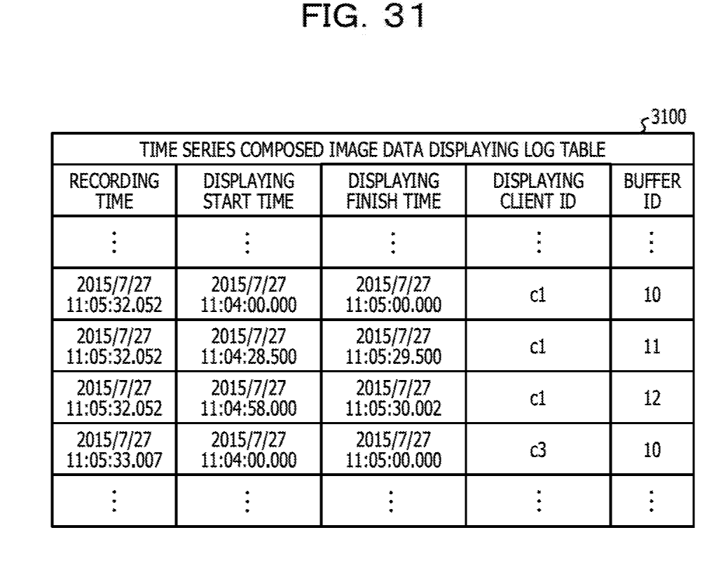

Next, a flow of the information providing processing for time series composed image data which is executed by the information providing unit 112 for time series composed image data of the server device 110 will be described. FIG. 30 is a flowchart of the information providing processing for time series composed image data which is executed by the server device and the processing is executed whenever more than a predetermined amount of sensor data is stored.

In Step S3001, the time series composed image data generation unit 1704 determines whether the action event 2120 newly occurs. In Step S3001, in a case where it is determined that the action event 2120 has not newly occurred, the time series composed image data generation unit 1704 waits until the action event 2120 newly occurs.

Meanwhile, in Step S3001, in a case where it is determined that the action event 2120 has newly occurred, the occurrence of the action event 2120 is recorded in the buffer table 2600 and the process proceeds to Step S3002. In Step S3002, the time series composed image data generation unit 1704 detects occurrence of reaction events 2520 and 2540 in response to the occurrence of the action event 2120 and records the detected result in the buffer table 2600.

In Step S3003, the time series composed image data generation unit 1704 transmits an action event to a client device other than the client device in which an action event has occurred and receives a notification of completion of receiving the action event from the client device which is a transmission destination.

In Step S3004, the time series composed image data generation unit 1704 calculates the communication speed based on the time taken from when an action event is transmitted to when a notification of completion of receiving the action event is received and records the calculation result in the event log table 2610.

In Step S3005, the time series composed image data generation unit 1704 refers to the movement type determination log table 2400 with respect to another avatar other than various tables (the buffer table 2600, the event log table 2610, and the displaying and reaction log table 2800). In this manner, the time series composed image data generation unit 1704 generates the time series composed image data generation information 2561. Further, the time series composed image data generation unit 1704 generates the image group 2110I′, the image group 2510I′, and the image group 2530I′ used for generation of time series composed image data based on the time series composed image data generation information 2561.

In Step S3006, the time series composed image data generation unit 1704 refers to the time series composed image data generation information 2561 and calculates a time difference in accordance with the deviation (arrow 2550) between the display timing information and reaction timing information. In addition, the time series composed image data generation unit 1704 synthesizes the image group 2110I and the image group 25101 of the VR space according to the time difference. Further, the time series composed image data generation unit 1704 refers to the time series composed image data generation information 2561 and calculates a time difference in accordance with the deviation (arrow 2550) between the display timing information and the reaction timing information. In addition, the time series composed image data generation unit 1704 synthesizes the image group 2510I and the image group 2530I of the VR space according to the time difference. In this manner, the time series composed image data 2500 is generated.

In Step S3007, the time series composed image data transmission unit 1705 predicts the time of the time series composed image data 2500 arriving at a client device based on the data size of the time series composed image data 2500 generated in Step S3006 and the communication speed calculated in Step S3003. In addition, the time series composed image data transmission unit 1705 determines the displaying start timing of the time series composed image data 2500 in the client devices 120 to 140. Further, the time series composed image data transmission unit 1705 refers to the time series composed image data generation information 2561, calculate the displaying time of respective image groups (the image group 2110I′, the image group 2510I′, and the image group 2530I′) and stores the calculated result in the time series composed image data displaying instruction information 2562.

In Step S3008, the time series composed image data transmission unit 1705 transmits the time series composed image data 2500 together with the time series composed image data displaying instruction information 2562 to the client devices 120 to 140 as the information of time series composed image data.

Further, when the time series composed image data 2500 is displayed in the client devices 120 to 140, the time series composed image data transmission unit 1705 records the displaying result in the time series composed image data displaying log table. FIG. 31 is a diagram illustrating an example of the time series composed image data displaying log table. As illustrated in FIG. 31, the client devices which are displaying destinations, the displaying start time, the displaying finish time, and the like are recorded in the time series composed image data displaying log table 3100.

As is evident from the description above, the reaction output system 100 generates image groups 2110I to 2530I of the VR space to which movements the respective avatars 250 to 270 in accordance with the behaviors of the users 150 to 170 in the real space are reflected. In addition, the reaction output system 100 generates the time series composed image data 2500 by synthesizing the generated image groups 2110I to 2530I of the VR space. Further, the reaction output system 100 performs synthesis with a time difference in accordance with a deviation between the timing at which a visual field image group is displayed (output timing) and the timing at which a user performs a behavior (reaction timing) when the time series composed image data 2500 is generated. Moreover, the reaction output system 100 controls the generated time series composed image data 2500 to be displayed in each client unit in a synchronized manner.

In this manner, each reaction of other users with respect to a behavior of a user can be displayed on a VR space as if the reactions of the users happened in the real space.

In other words, movements of avatars, to which individual reactions of other people with respect to a movement of an avatar to which a behavior of a person is reflected are reflected, in the VR space used by a plurality of people can be synthesized and output without changing the timing at which respective reactions with respect to the behavior occur.

Second Embodiment

In the first embodiment described above, the reaction output system determines the type of movement with respect to another avatar. However, in a second embodiment, the reaction output system determines the tendency of a movement with respect to another avatar. The tendency of movement with respect to another avatar is obtained by determination of whether a movement of an avatar, to which a social behavior of a user performed with respect to another user has a tendency of approaching or a tendency of avoiding in the relationship with anther avatar. Hereinafter, the second embodiment will be described focusing on differences from the first embodiment.

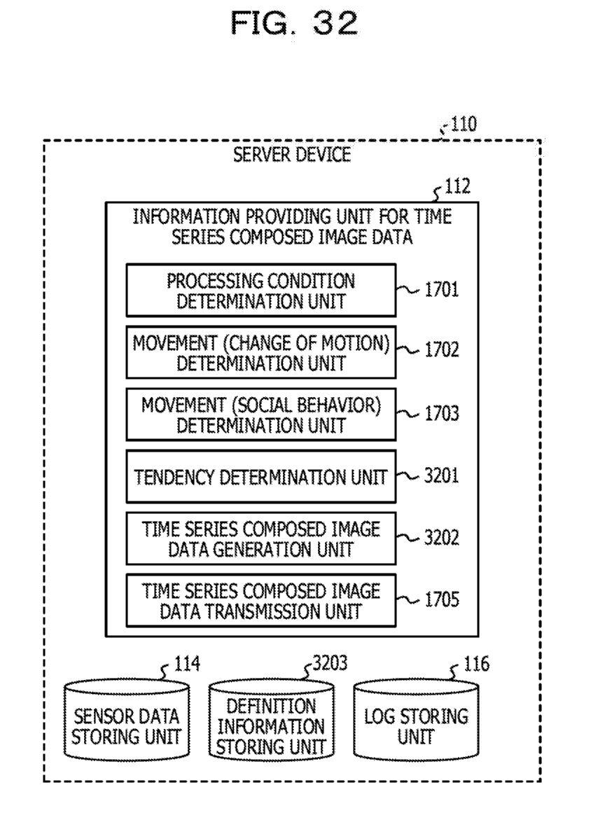

First, the functional configuration of the server device 110 of the second embodiment will be described. FIG. 32 is a third diagram illustrating an example of the functional configuration of the server device. Differences of this functional configuration from the functional configuration illustrated in FIG. 17 are the presence of a tendency determination unit 3201, the function of time series composed image data generation unit 3202 which is different from the function of the time series composed image data generation unit 1704, and a definition information storing unit 3203 which has definition information related to the tendency and the type of movement with respect to another avatar.

The tendency determination unit 3201 determines whether the tendency of movement with respect to another avatar determined by the movement (social behavior) determination unit 1703 is a tendency of approaching or a tendency of avoiding. The tendency determination unit 3201 refers to definition information, in which the relationship between type and the tendency of movement with respect to another avatar is defined, among definition information stored in the definition information storing unit 3203. In this manner, the tendency determination unit 3201 determines whether the movement of an avatar, to which a social behavior of a user with respect to another user is reflected, is a tendency of approaching or a tendency of avoiding in the relationship with another avatar.

Moreover, the priority order of the movement with respect to another avatar is associated with the definition information in which the relationship between the type and the tendency of movement with respect to another avatar is defined. When the tendency determination unit 3201 determines whether the movement of an avatar, to which a social behavior of a user with respect to another user is reflected, is a tendency of approaching or a tendency of avoiding in the relationship with another avatar, the tendency determination unit 3201 also acquires the priority order.

At the time of generating time series composed image data, the time series composed image data generation unit 3202 generates time series composed image data in a display mode (the color, the size, and the like) in accordance with the determination result determined by the tendency determination unit 3201 and the priority order acquired by the tendency determination unit 3201. Moreover, examples of the display mode include a display mode in which an emphasis degree is strengthened and a display mode in which an emphasis degree is weakened. Further, examples of the display mode in which the emphasis degree is weakened include a display mode of making a color to be displayed to be transparent and a display mode of softening a color to be displayed.

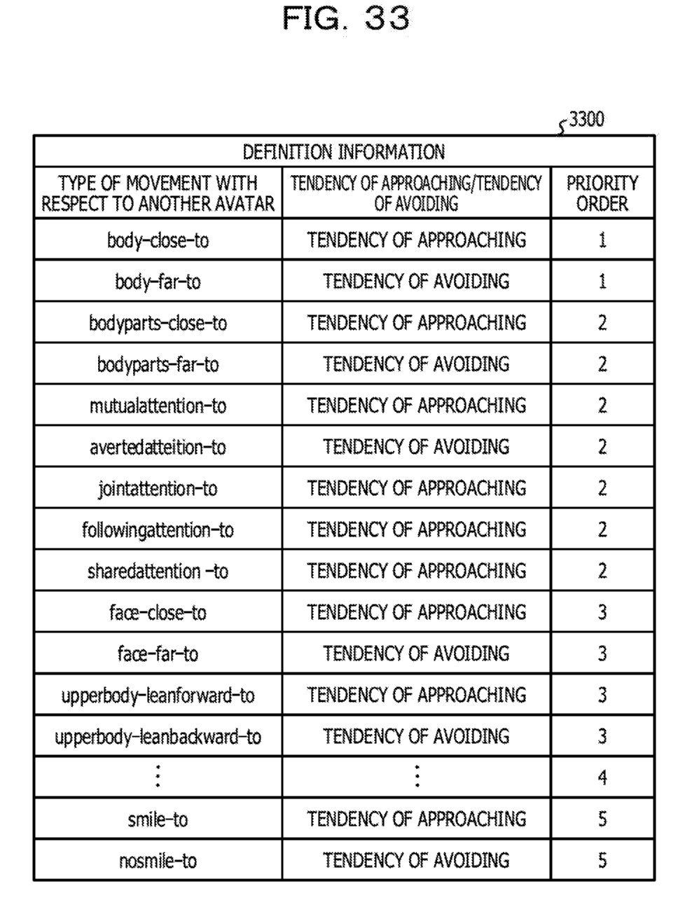

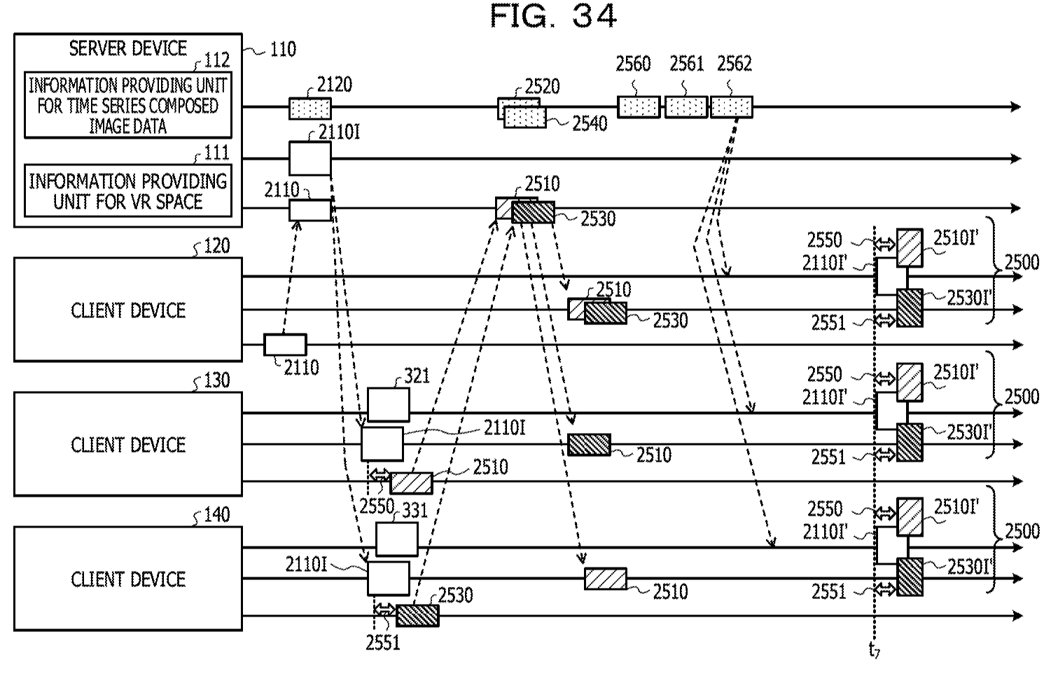

Next, definition information in which the relationship among the type, the tendency, and the priority order of movement with respect to another avatar is defined will be described. FIG. 33 is a diagram illustrating an example of definition information in which the relationship among the type, the tendency, and the priority order of movement with respect to another avatar is defined.

As illustrated in FIG. 33, the definition information includes, as items of information, “type of movement with respect to another avatar”, “tendency of approaching and tendency of avoiding”, and “priority order”.

The type of movement with respect to another avatar which may be determined by the movement (social behavior) determination unit 1703 is stored in the “type of movement with respect to another avatar”. Either of the tendency of approaching and the tendency of avoiding is stored in the “tendency of approaching and tendency of avoiding” for each type of movement with respect to another avatar.

The priority order allocated to the type of movement with respect to another avatar is stored in the “priority order”. For example, in a case where two kinds of movements are performed in the same time range and the types of movements with respect to another avatar are respectively determined, it is assumed that the tendency of one determination result is a tendency of approaching and the tendency of the other determination result is a tendency of avoiding. At this time, the tendency determination unit 3201 determines which tendency is employed as the determination result in the time range according to the priority order stored in the “priority order”. Further, for example, it is assumed that the priority order of the type of movement with respect to another avatar which is determined at the time of generation of time series composed image data is high. At this time, the time series composed image data generation unit 3202 generates time series composed image data so as to have a display mode in which the emphasis degree is strengthened compared to a case where the priority order of the type of movement with respect to another avatar is low. On the contrary, the time series composed image data generation unit 3202 generates time series composed image data so as to have a display mode in which the emphasis degree is weakened in the case where the priority order is low.

As illustrated in FIG. 33, in a case where the movement (social behavior) determination unit 1703 determines the type of movement with respect to another avatar as “body-close-to”, the tendency determination unit 3201 determines the tendency of movement with respect to another avatar as the “tendency of approaching”. Moreover, the priority order to be acquired at this time is “1”. In this manner, at the time of generating the time series composed image data 2500, the time series composed image data generation unit 1704 is capable of generating the time series composed image data 2500 with the “tendency of approaching” which is the tendency of movement with respect to another avatar and in a display mode in which the priority order corresponds to “1”.

In this manner, according to the reaction output system of the second embodiment, a tendency of movement of an avatar, which corresponds to a social behavior of a user performed with respect to another user, is determined according to the determined type of movement with respect to another avatar. In this manner, the type of movement with respect to another avatar which reflects to time series composed image data or the display mode thereof may be changed.

Third Embodiment

In the first and second embodiments, attributes of a plurality of people communicating with each other in a VR space have not been described, but the plurality of people communicating each other in the VR space may be classified into a plurality of groups according to the attributes.

Classification of the plurality of people into a plurality of groups is advantageous for a case where it is not possible to determine whether a movement of an avatar to which a social behavior of a user is reflected is targeting an avatar of another user only with the orientation of the face or the orientation of the body of the user. This is because it is possible to roughly determine which group the movement of an avatar to which a social behavior of the user is reflected is targeting for.

For example, a case where the user belongs to a predetermined group and a movement of an avatar, to which a social behavior of the user is reflected, is determined is considered. In this case, positions of avatars of other users in the VR space are classified according to groups to which other users respectively belong and figures that roughly cover the positions of avatars are set for each group in the VR space.

In this manner, a position of an avatar of a user belonging to another group can be roughly specified and it is possible to determine whether the movement of an avatar to which a social behavior of the user to be determined is reflected is targeting for any other group.

Moreover, in a case where it is determined that the movement of an avatar to which a social behavior of the user to be determined is reflected is targeting for any other group, the group name which is a determination result may be written in the movement type determination log table 2400 with respect to another avatar. Alternatively, all user names belonging to a group which is the determination result may be written in the movement type determination log table 2400 with respect to another avatar.

Meanwhile, even in the classification into a plurality of groups, it is occasionally difficult to determine whether a movement of an avatar to which a social behavior of a user to be determined is reflected is targeting for an avatar of another user belonging to the same group or a user belonging to another group.

This is because a position of an avatar of another user belonging to the same group and a position of an avatar of a user belonging to another group are occasionally in the same direction with respect to the orientation of a face of an avatar to which a social behavior of a user to be determined is reflected.

In this case, it is effective to obtain a focal distance of an eyegaze of a user to be determined by installing an eyegaze sensor as a sensor that senses a behavior of a user and acquiring three-dimensional eyegaze data. This is because a target of a movement of an avatar to which a social behavior of a user to be determined is reflected can be distinguished since a distance between a position of an avatar of a user to be determined and a position of an avatar of another user belonging to the same group is different from a position of an avatar of a user to be determined and a position of an avatar of another user belonging to another group.

Alternatively, a target may be distinguished based on voice data such as a murmur of a user to be determined. Alternatively, in a case where another user directly inquires a user to be determined through a voice, a target may be distinguished based on the inquiry result.

Alternatively, in a case where a movement of an avatar to which a social behavior of a user to be determined is reflected is a movement that causes a reaction event, a target may be distinguished based on which action event the reaction event is resulting from.

In this manner, in a case where avatars of users belonging to different groups are present in the same VR space, users belonging to different groups can be involved in construction of a human relationship of users belonging to a predetermined group. However, when it is possible to determine which group the movement of an avatar to which a social behavior of the user is reflected is targeting for, it is possible to determine whether the movement of an avatar to which a social behavior of the user is reflected is targeting for an avatar of a user belonging to the same group and to perform management separately.

Fourth Embodiment

In the first and second embodiments, time series composed image data is described as a group obtained by synthesizing image groups of the VR space. That is, the description has been made that an avatar which is the same as the avatar displayed in a visual field image group is used for generation of time series composed image data, but the avatar used for time series composed image data may be an avatar different from the avatar displayed in a visual field image group.

In addition, in the above-described first and second embodiments, a method of displaying time series composed image data is not particularly mentioned, but time series composed image data may be time series image data when the VR space is comprehensively viewed or time series image data when the VR space is viewed from a specific user.

Further, the client devices 120 to 140 may have some of the functions described to be included in the server device 110 according to the first and second embodiments. Alternatively, the server device 110 may have some of the functions described to be included in the client devices 120 to 140 according to the first and second embodiments. That is, distinguishment of the functions between the server device 110 and the client devices 120 to 140 described in the first and second embodiments is merely an example and an optional combination is also possible.

Moreover, in the first and second embodiments, the description has been made that the time series composed image data 2500 is generated in the server device 110 and the time series composed image data is transmitted to the client devices 120 to 140. However, the time series composed image data 2500 may be generated in the client devices 120 to 140. FIG. 34 is a second diagram for describing a flow from a behavior of a user to displaying of time series composed image data.

A difference from FIG. 25 is that the server device 110 transmits the sensor data group 2510 received from the client device 130 to the client devices 120 and 140. Further, another difference from FIG. 25 is that the server device 110 transmits the sensor data group 2530 received from the client device 140 to the client devices 120 and 130. Further, still another difference from FIG. 25 is that the server device 110 transmits the time series composed image data generation information 2561 and the time series composed image data displaying instruction information 2562 to the client devices 120 to 140.

In this manner, the client devices 120 to 140 are capable of generating the time series composed image data 2500 and reproducing the time series composed image data 2500. Further, in this case, the client devices 120 to 140 have a function of generating an avatar in the VR space based on the sensor data group.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A reaction output apparatus, comprising:
a memory storing image group information including a virtual space and a plurality of avatars, each avatar within the virtual space represents a person in a real space; and
a processor configured to:
obtain sensor information that indicates movement of a first person and a second person;
generate an image group based on the virtual space including a first avatar indicating movement of the first person in the real space and a second avatar to indicate movement of a second person;
determine an action event based on the movement of the first person;
wait a period of time to determine if the second person reacts to the movement of the first person;
create group representation including the first avatar and the second avatar and the action event;
output the group representation to a first client device associated with the first person and a second client device associated with the second person.

2. The reaction output apparatus according to claim 1, wherein the processor is further configured to:
calculate a first time to provide the group representation to the first client device and a second time to provide the group information to the second device; and
output the group representation such that start timing of display on the first device and the second device is synchronized.

3. The reaction output apparatus according to claim 1, wherein the processor is further configured to:
determine the type of movement with respect to the second avatar; and
identify a reaction event if the second person reacts to the movement of the first person; and
include the reaction event in the group representation when the second person reacts.

4. A reaction output system comprising:
a first terminal apparatus including a first display;
a second terminal apparatus including a second display; and
a reaction output apparatus including:
a memory; and
a processor coupled to the memory and the processor configured to:
transmit a first image to the second terminal apparatus, the first image corresponding to a first motion of a first person detected in the first terminal apparatus;
detect, after outputting the first image on the second display, a motion of a second person on the second terminal apparatus;
specify a first time interval from the outputting the first image to the detecting the motion of the second person; and
transmit a second image to the first terminal apparatus, the second image corresponding to a second motion of the second person detected in the second terminal apparatus, the second image indicating that the second motion occurs after the first time interval from an occurrence of the first motion.

5. The reaction output system according to claim 4, wherein
the second image is output on the first display.

6. The reaction output system according to claim 4, wherein
the processor is further configured to:
determine whether the detected second motion is a motion having a tendency of approaching the first person shown in the first image or a motion having a tendency of avoiding the first person shown in the first image, and
change a display mode for the second image according to a determined tendency of the second motion.

7. The reaction output system according to claim 4, wherein
the reaction output system further comprises a third terminal apparatus including a third display; wherein
the processor is further configured to:
transmit the first image to the third terminal apparatus;
detect, after outputting the first image on the third display, a motion of a third person on the third terminal apparatus;
specify a second time interval from the outputting the first image to the detecting the motion of the third person; and
transmit a third image to the first terminal apparatus, the third image corresponding to the second motion and a third motion of the third person detected in the third terminal apparatus, the third image indicating that the second motion occurs after the first time interval from an occurrence of the first motion and indicating that the third motion occurs after the second time interval from an occurrence of the first motion.

8. The reaction output system according to claim 7, wherein
the processor is further configured to:
determine whether the detected third motion is a motion having a tendency of approaching the first person shown in the first image or a motion having a tendency of avoiding the first person shown in the first image, and
change a display mode for the third image according to a determined tendency of the third motion.

9. The reaction output system according to claim 7, whrein
the processor is further configured to:
determine a timing for displaying the third image on the first display, a timing for displaying the third image on the second display and a timing for displaying the third image on the first display based on a communication speed between the first terminal apparatus and the second terminal apparatus and a communication speed between the first terminal apparatus and the third terminal apparatus.

10. A non-transitory computer-readable storage medium storing a reaction output program that causes a computer to execute a process, the process comprising:
transmitting a first image to a second terminal apparatus, the first image corresponding to a first motion of a first person detected in a first terminal apparatus;
detecting, after outputting the first image on a second display including the second terminal apparatus, a motion of a second person on the second terminal apparatus;
specifying a first time interval from the outputting the first image to the detecting the motion of the second person; and
transmitting a second image to the first terminal apparatus, the second image corresponding to a second motion of the second person detected in the second terminal apparatus, the second image indicating that the second motion occurs
after the first time interval from an occurrence of the first motion.
